(19) United States
(12) Patent Application Publication
(10) Pub. No.: US 2011/0234345 A1
(43) Pub. Date: Sep. 29, 2011

(54) COMBINED MAGNETIC BODY, COMBINED MAGNETIC BODY PRODUCTION METHOD, COMBINED MAGNETIC BODY INJECTION APPARATUS, COMBINED MAGNETIC BODY INJECTION CONTROL SYSTEM, MAGNETIC FIELD CONTROL APPARATUS AND COMBINED MAGNETIC BODY INJECTION CONTROL METHOD

(76) Inventors: Hiroshi Onodera, Miyagi (JP); Atsushi Nakahira, Osaka (JP)

(21) Appl. No.: 12/377,774

(22) PCT Filed: Nov. 28, 2008
(86) PCT No.: PCT/JP2008/071676

§ 371 Date: Feb. 17, 2009

(51) Int. Cl. H01F 7/02; B05D 5/00; B05D 3/00; B82Y 25/00

(52) U.S. Cl. 335/302; 427/130; 977/762

(57) ABSTRACT

According to one aspect of the present invention, a combined magnetic body includes a plurality of nanowires composed of a magnetic material. In the combined magnetic body, the nanowires are combined together to be formed into a tubular structure or a basket-shaped structure.

### TECHNICAL FIELD

The present invention relates to a combined magnetic body, a combined magnetic body production method, a combined magnetic body injection apparatus, a combined magnetic body injection control system, a magnetic field control apparatus, and a combined magnetic body injection control method.

### BACKGROUND ART

Heretofore, magnetic nanowires whose position in a living body can be controlled have been developed.

For example, Patent Document 1 discloses a magnetic nanowire having an antibody, a drug, or the like coupled to the surface thereof, which is used to control the position of a drug for extending neurites extended from neuronal cells in a living body. The nanowire is mainly made of, for example, iron and has a diameter equal to or less than 300 nm and a length equal to or less than 300 μm.
Patent Document 1: JP-A-2008-007478

### DISCLOSURE OF INVENTION

### Problem to be Solved by the Invention

However, a conventional nanowire as typified by the nanowire disclosed in Patent Document 1 is poor in tissue penetrating power, and therefore cannot penetrate tissue such as the pia mater located between blood vessels and the brain or spinal cord.

Furthermore, when nanowires of a certain size or smaller (e.g., nanowires having a diameter of about 50 nm that is substantially the same size as bacteria) are injected into a living body, the nanowires are immediately phagocytized by phagocytes such as microglias after a lapse of a certain period of time. Therefore, such nanowires are not suitable as, for example, scaffolds for constructing neuronal circuits over a long period of time. On the other hand, when nanowires of a certain size or larger (e.g., nanowires having a diameter of about 200 nm) are injected into a living body, the nanowires can be placed at a target site for a long period of time, but cannot be phagocytized by phagocytes such as microglias. Therefore, such nanowires are inferior in removability.

As described above, the conventional nanowire can have an antibody, a drug, or the like coupled to the surface thereof, but there are limits on the amount and size of such a material that can be coupled to the surface of the nanowire. Therefore, the conventional nanowire cannot be used to transport a certain amount or more of drug or the like or a large-sized object such as a stem cell.

In view of the above problems, it is an object of the present invention to provide a combined magnetic body that has a higher tissue penetrating power than before and is capable of achieving both long-term placement in a living body and removal by phagocytes and of transporting a larger amount of material than before or a larger-sized object than before, a combined magnetic body production method for producing the combined magnetic body, an combined magnetic body injection apparatus for injecting the combined magnetic body, a combined magnetic body injection control system for controlling the injection of the combined magnetic body, a magnetic field control apparatus for controlling the movement of the combined magnetic body, and a combined magnetic body injection control method for controlling the injection of the combined magnetic body.

### Means for Solving Problem

To solve the above problems and to achieve the above objectives, according to an aspect of the present invention, a combined magnetic body includes a plurality of nanowires composed of a magnetic material. In the combined magnetic body, the nanowires are combined together to be formed into a tubular structure or a basket-shaped structure.

According to another aspect of the present invention, in the combined magnetic body, the tubular structure or the basket-shaped structure accommodates a cell, a protein, a hormone, a peptide, a drug, an organic compound, a nucleic acid, sugar, or lipid.

According to still another aspect of the present invention, in the combined magnetic body, the nanowires constitute a core layer. The core layer is coated with an intermediate layer containing a phagocytic signal. The intermediate layer is coated with a functional layer containing a biofunctional molecule.

According to still another aspect of the present invention, in the combined magnetic body, the functional layer contains, as the biofunctional molecule, a drug, a protein, sugar, a virus vector, siRNA (small interfering RNA), an antibody, a growth factor, or an extracellular matrix.

According to still another aspect of the present invention, in the combined magnetic body, the intermediate layer or the functional layer contains a substrate to be liberated such as an organic material (e.g., methacrylate), fibrin, a matrix protein, polysaccharide, heparin, a heparin-like molecule, or polylactic acid.

According to still another aspect of the present invention, a combined magnetic body production method for producing a combined magnetic body includes a first step of preparing a suspension by suspending a plurality of nanowires composed of a magnetic material, and a second step of immersing a soluble rod-shaped body in the suspension. The combined magnetic body production method further includes a third step of drying the suspension adhered to the rod-shaped body, and a fourth step of dissolving the rod-shaped body to form a tubular or basket-shaped combined magnetic body in which the nanowires are combined together.

According to still another aspect of the present invention, a combined magnetic body injection apparatus includes a combined magnetic body filling tube, the tube being composed of a light-permeable nonmagnetic material and having a hole larger than a diameter of the combined magnetic body. The combined magnetic body injection apparatus further includes a light detecting system that detects light crossing a cross section of the tube near a tip of the tube, and a shutter system that controls the opening and closing of the hole of the tube.

According to still another aspect of the present invention, in the combined magnetic body injection apparatus, the shutter system has a plug structure that prevents the combined magnetic body from being injected through the hole of the tube. The plug structure is slidably inserted into and removed from the hole of the tube to control the opening and closing of the hole.

According to still another aspect of the present invention, a combined magnetic body injection control system includes a combined magnetic body injection apparatus, and a magnetic field control apparatus. The combined magnetic body injection apparatus includes a combined magnetic body filling tube composed of a light-permeable nonmagnetic material and having a hole larger than a diameter of the combined magnetic body. The magnetic field control apparatus includes a magnetic field generator that generates magnetic field for guiding the combined magnetic body, and a control unit that controls the movement of a magnetic field shielding plate for blocking the magnetic field.

According to still another aspect of the present invention, a magnetic field control apparatus includes a magnetic field generator that generates magnetic field for guiding the combined magnetic body. The magnetic field control apparatus further includes a guide needle that increases a magnetic flux density of the magnetic field generated by the magnetic field generator, and a control unit that controls the movement of a magnetic field shielding plate for blocking the magnetic field between the magnetic field generator and the guide needle.

According to still another aspect of the present invention, a combined magnetic body injection control method is executed by a combined magnetic body injection control system. The system includes a combined magnetic body injection apparatus, and a magnetic field control apparatus. The combined magnetic body injection apparatus includes a combined magnetic body filling tube composed of a light-permeable nonmagnetic material and having a hole larger than a diameter of the combined magnetic body, a light detecting system that detects light crossing a cross section of the tube near a tip of the tube, and a shutter system that controls the opening and closing of the hole of the tube. The magnetic field control apparatus includes a magnetic field generator that generates magnetic field for guiding the combined magnetic body, and a control unit that controls the movement of a magnetic field shielding plate for blocking the magnetic field. The combined magnetic body injection control method includes a first step of moving the magnetic field shielding plate to allow the magnetic field generated by the magnetic field generator to pass, the step is executed by the control unit of the magnetic field control apparatus. The method further includes a second step of controlling the shutter system to open the hole of the tube, and a third step of checking whether the combined magnetic body has been injected by controlling the light detecting system to detect the light crossing the cross section of the tube, the steps are executed by the combined magnetic body injection apparatus.

### Effect of the Invention

According to the present invention, it is possible to provide a combined magnetic body that has a high tissue penetrating power and is capable of achieving both long-term placement in a living body and removal by phagocytes and of transporting a large amount of material or a large-sized object, a combined magnetic body production method for producing the combined magnetic body, an combined magnetic body injection apparatus for injecting the combined magnetic body, a combined magnetic body injection control system for controlling the injection of the combined magnetic body, a magnetic field control apparatus for controlling the movement of the combined magnetic body, and a combined magnetic body injection control method for controlling the injection of the combined magnetic body.

### BRIEF DESCRIPTION OF THE DRAWINGS

FIG. 1 is a diagram for explaining one example of the structure of a combined magnetic body according to the present invention;

FIG. 2 is a flow chart with schematic diagrams for explaining one example of a method for producing nanowires;

FIG. 3 is a schematic diagram for explaining one example of the process of formation of porous alumina;

FIG. 4 is an electron micrograph of one example of nanowires produced;

FIG. 5 is a schematic diagram for explaining one example of the surface structure of a silane coupling-treated nanowire;

FIG. 6 provides scanning electron microscope (SEM) images of one example of iron nanowires taken before and after coating with a silane coupling agent;

FIG. 7 is a graph for explaining the result of energy dispersive X-ray (EDX) analysis of a silane coupling-treated nanowire;

FIG. 8 is a diagram for explaining one example of the surface structure of a nanowire coated with gold;

FIG. 9 is a flow chart with schematic diagrams for explaining one example of a method for forming a basket-shaped combined magnetic body;

FIG. 10 is a diagram for explaining one example of the total structure of a combined magnetic body injection control system;

FIG. 11 is a diagram for explaining one example of the structure of a combined magnetic body injection apparatus 100;

FIG. 12 is a schematic diagram for explaining one example of the structure of a combined magnetic body filling tube 10;

FIG. 13 is a diagram for explaining one example of the cross section of an applicator 40;

FIG. 14 is a diagram for explaining another example of the cross section of the applicator 40;

FIG. 15 is a diagram of one example of a filling instrument 11 for use in attaching the combined magnetic body filling tubes 10 filled with combined magnetic bodies to the applicator 40;

FIG. 16 is a schematic diagram for explaining the injection of combined magnetic bodies 1 contained in the combined magnetic body filling tube 10 through a shutter 30;

FIG. 17 is a diagram of one example of the shutter 30 of a shutter rotation type or an applicator rotation type;

FIG. 18 is a diagram of another embodiment of the shutter system;

FIG. 19 is a schematic diagram for explaining one example of magnetic field control carried out by a control unit 60;

FIG. 20 is a diagram of an improved version of the control unit 60 shown in FIG. 19;

FIG. 21 is a diagram of the improved version of the control unit 60 shown in FIG. 19;

FIG. 22 is a schematic diagram for explaining the chain formation of the magnetic bodies in their longitudinal direction;

FIG. 23 is a diagram for explaining one example of the surface structure of an antibody-coupled wire for general purpose use;

FIG. 24 is a schematic diagram for explaining one example of the surface structure of a drug-eluting nanowire;

FIG. 25 is a sectional diagram of one example of a magnetic wire obtained by laminating an intermediate layer containing a phagocytic signal on a nanowire as a core layer and further laminating a functional layer containing biological functional molecules on the intermediate layer;

FIG. 26 is a photomicrograph for explaining the removal of nanowires from a transplantation site by phagocytes;

FIG. 27 is a photomicrograph of a meshed wire (combined magnetic body) obtained by forming 50 nm wires into a mesh structure;

FIG. 28 is a schematic diagram for explaining a situation where combined magnetic bodies are aligned by magnetic field so as to cross an affected site at which nerve connections (represented by the left and right arrow) between a region A and a region B are blocked by nerve damage and lose their function;

FIG. 29 is a schematic diagram for explaining a situation where neurites or transplanted neuronal cells move along nanowires (combined magnetic bodies) having nerve function control molecules, such as a cell spreading factor (a cell adhesion molecule or a factor affecting neurite outgrowth), coupled to the surface thereof so that neuronal circuits are formed between the transplanted neuronal cells and target neuronal cells;

FIG. 30 is a three-dimensional computerized tomography (CT) image of the brain of a rat; and

FIG. 31 is a micrograph taken when nanowires (50 nm) injected into the brain of a rat were guided by externally-applied magnetic field using a permanent magnet.

### EXPLANATIONS OF LETTERS OR NUMERALS

1 combined magnetic body
10 combined magnetic body filling tube
11 filling instrument
20 light detecting device
30 shutter
40 applicator
50 guide needle
60 control unit
61 magnetic body
62 magnetic field shielding plate
70 magnet
100 combined magnetic body injection apparatus
200 magnetic field control apparatus

### BEST MODES FOR CARRYING OUT THE INVENTION

Embodiments of a combined magnetic body, a combined magnetic body production method, a combined magnetic body injection apparatus, a combined magnetic body injection control system, a magnetic field control apparatus, and a combined magnetic body injection control method according to the present invention will be explained in detail with reference to the accompanying drawings. The present invention is not limited to the embodiments. Particularly, some of the embodiments of the present invention will be described about a case where the combined magnetic body according to the present invention is applied in a clinical setting for, for example, improvement in nerve function, but the application of these embodiments is not limited thereto. For example, these embodiments may be applied to a novel drug delivery system, screening of new drugs, or basic researches such as brain function analysis.

Outline of the Present Invention

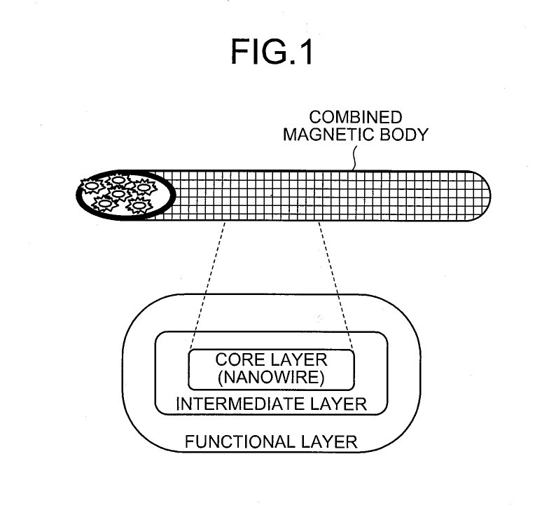

An outline of the present invention will be explained with reference to FIG. 1, and thereafter, the configuration, processes, and the like of the present invention will be explained in details. FIG. 1 is a diagram for explaining one example of the structure of a combined magnetic body according to the present invention.

As shown in FIG. 1, the combined magnetic body according to the present invention includes a plurality of nanowires (e.g., diameter: 50 nm or more, length: 1 μm or less) composed of a magnetic material. In the combined magnetic body, the nanowires are combined together to be formed into a tubular structure or a basket-shaped structure (e.g., diameter: 1000 μm or less, length: 3 mm or less). The magnetic material of the nanowire may be metal such as iron, gold, copper, lead, nickel, or platinum.

The combined magnetic body according to the present invention may have a cell (e.g., a neuronal cell), a protein, a hormone, a peptide, a drug, an organic compound, a nucleic acid, sugar, lipid or the like, that are stored in the tubular structure or the basket-shaped structure. The surface of the magnetic body may be coupled to a protein (e.g., an adhesion molecule, a growth factor, an antibody), a hormone, a peptide, a drug, an immunosuppressive agent, an organic compound (a drug elution speed control material, a visualizing dye, fluorescent dye, magnetic body-stabilizing agent), a gene (e.g., a virus vector, DNA, RNA), sugar, polysaccharide (e.g., polylactic acid), lipid, glycolipid, metal (e.g., safety, stable or magnetically-controllable material in tissue, such as platinum, gold, iron, or titanium), or the like.

As shown in the sectional diagram on the under side of FIG. 1, in the combined magnetic body of the present invention, the nanowires may constitute a core layer. The core layer may be coated with an intermediate layer containing a phagocytic signal (e.g., poly-L-lysine signal) for phagocytes such as macrophages or microglias, and the intermediate layer may be coated with a functional layer containing a biofunctional molecule. Examples of the biofunctional molecule includes a drug, a protein, sugar, a virus vector, nucleic acid (e.g., RNA, DNA), an antibody (e.g., an anti-Nogo antibody, an anti-myelin-associated protein antibody), a growth factor (e.g., a glial cell derived neurotrophic factor (GDNF), a hepatocyte growth factor (HGF)), an extracellular matrix, laminin, fibronectin, a neural cell adhesion molecule (NCAM), nectin, cadherin, a chemokine, a cytokine, and the like. The intermediate layer, the functional layer, the tubular structure, or the basket-shaped structure contains a substrate to be liberated such as an organic material (e.g., methacrylate), fibrin, a matrix protein, polysaccharide (e.g., lectin, which binds sugar), heparin, a heparin-like molecule, polylactic acid, or polylysine.

Another aspect of the present invention is involved in a method for producing the combined magnetic body. The method includes a first step of preparing a suspension by suspending a plurality of nanowires composed of a magnetic material, and a second step of immersing a soluble rod-shaped body in the suspension. The method further includes a third step of drying the suspension adhered to the rod-shaped body, and a fourth step of dissolving the rod-shaped body to obtain the combined magnetic body.

Another aspect of the present invention is involved in a injection apparatus for the combined magnetic body. The injection apparatus includes a combined magnetic body filling tube, the tube being composed of a light-permeable nonmagnetic material and having a hole larger than a diameter of the combined magnetic body. The injection apparatus further includes a light detecting system that detects light crossing a cross section of the tube near a tip of the tube, and a shutter system that controls the opening and closing of the hole of the tube.

Still another aspect of the present invention is involved in a magnetic field control apparatus for guiding the combined magnetic body. The magnetic field control apparatus includes a magnetic field generator that generates magnetic field for guiding the combined magnetic body. The magnetic field control apparatus further includes a guide needle that increases a magnetic flux density of the magnetic field generated by the magnetic field generator, and a control unit that controls the movement of a magnetic field shielding plate for blocking the magnetic field between the magnetic field generator and the guide needle.

Still another aspect of the present invention is involved in a system including the combined magnetic body injection apparatus and the magnetic field control apparatus, and a method executed by the system for controlling the injection of the combined magnetic body. The method includes a first step of moving the magnetic field shielding plate to allow the magnetic field generated by the magnetic field generator to pass, the step is executed by the control unit of the magnetic field control apparatus. The method further includes a second step of controlling the shutter system to open the hole of the tube, and a third step of checking whether the combined magnetic body has been injected by controlling the light detecting system to detect the light crossing the cross section of the tube, the steps are executed by the combined magnetic body injection apparatus.

This is the outline of the present invention.

Method for Producing Combined Magnetic Body

One example of the method for producing the combined magnetic body will be explained below.

Method for Producing Nanowires

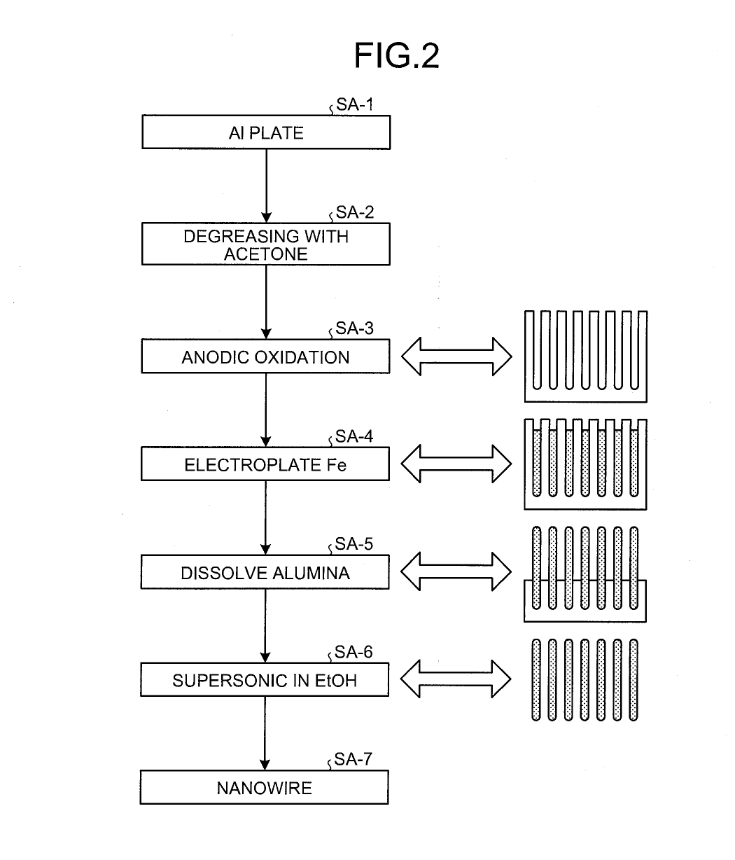

First of all, a method for producing nanowires is explained since the combined magnetic body is made by combining the nanowires, which is composed of a magnetic material, together. FIG. 2 is a flow chart with schematic diagrams for explaining one example of the method for producing nanowires.

As shown in FIG. 2, an aluminum plate is prepared (Step SA-1), and then degreasing of the plate is carried out using acetone (Step SA-2).

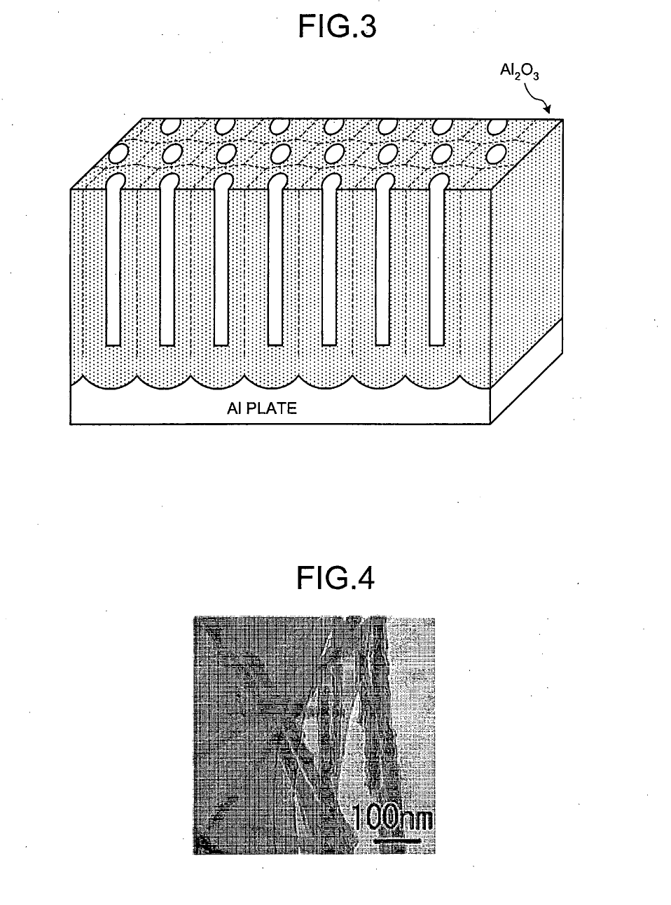

Then, the aluminum (aluminum plate) is anodized in an electrolytic solution such as oxalic acid or sulfuric acid to form anodized porous alumina having pores in the surface thereof (Step SA-3). Examples of conditions for carrying out this step are as follows. As the electrolytic solution, 0.05 to 1.0 M sulfuric acid (H₂SO₄) is used. Electrolysis is carried out at a DC voltage of 15 V for 1 to 24 hours using the aluminum plate as an anode and a carbon electrode as a cathode. It is to be noted that these conditions are merely examples, and the diameter and length of pores formed in the surface of aluminum can be controlled by appropriately setting the composition of the electrolytic solution, current density, and electrolysis time, etc. According to this method, nanopores each having a diameter of about 10 to 300 nm and a length of about 1 to 300 μm are formed. FIG. 3 is a schematic diagram for explaining one example of the process of formation of porous alumina.

An oxide film is grown by the reaction between Al³⁺ ions and O²⁻ ions, which move in opposite directions in the oxide, at the interface between the solution and aluminum. When the electrolytic solution begins to dissolve part of the oxide film, the thickness of the part is reduced so that electrolysis is promoted in the film. This accelerates the movement of Al³⁺ and O²⁻ so that the film of Al₂O₃ is grown. Then, as shown in FIG. 3, nanopores uniformly spaced are formed because the dissolution and the film growth proceed at the same time and the film growth occurs by priority at a portion where the concentration of the electrolytic solution is high.

The anodized porous alumina is used as a mold to fill the nanopores with iron by electrolytic deposition (so-called electrolytic plating) (Step SA-4). Examples of conditions for carrying out this step are as follows. An electrolytic solution has the following composition: FeSO₄.7H₂O (5.0 g), H₃BO₄ (2.5 g), H₂O (100 mL), L-Ascorbic Acid (0.1 g), and Glycerol (0.2 mL). Electrolysis is carried out at an AC voltage of 15 V for 5 minutes. It is to be noted that a nanowire made of iron and a metal other than iron alternately arranged in the longitudinal direction thereof can also be formed by depositing two or more metals including iron alternately by electrolysis. Examples of the metal other than iron include gold, nickel, and platinum.

Then, the anodized porous aluminum is dissolved with a weak acid or alkali to obtain nanowires formed in the nanopores (Step SA-5). Examples of conditions for carrying out this step are as follows. A solution for dissolving the anodized porous aluminum has the following composition: H₂O (100 mL), H₃PO₄ (1.6 g), and CrO₃ (0.8 g). The time for dissolution is 0 to 25 minutes.

Finally, the nanowires are cleaned in ethanol by ultrasonication (Step SA-6) to complete the nanowires (Step SA-7).

This is the example of the method for nanowires. FIG. 4 is an electron micrograph of one example of the nanowires produced. It is to be noted that if necessary, various organic substances (e.g., polylysine, an antibody, a drug) may be coupled to the nanowire. Furthermore, the surface of the nanowire may be treated with a metal such as gold to prevent oxidation. In this case, the surface of the nanowire is preferably treated with a silane coupling agent to enhance the degree of coupling between the nanowire and the metal.

Silane Coupling

One example of treatment for coating the surface of nanowires with gold by using a silane coupling agent will be explained below.

First, the nanowires are subjected to ultrasonication in a 1.0 wt % 3-mercaptopropyltrimethoxysilane solution. The 1.0 wt % 3-mercaptopropyltrimethoxysilane solution is prepared by, for example, mixing 0.2 g of 3-mercaptopropyltrimethoxysilane, 10 mg of ion-exchanged water, and 10 mg of ethanol.

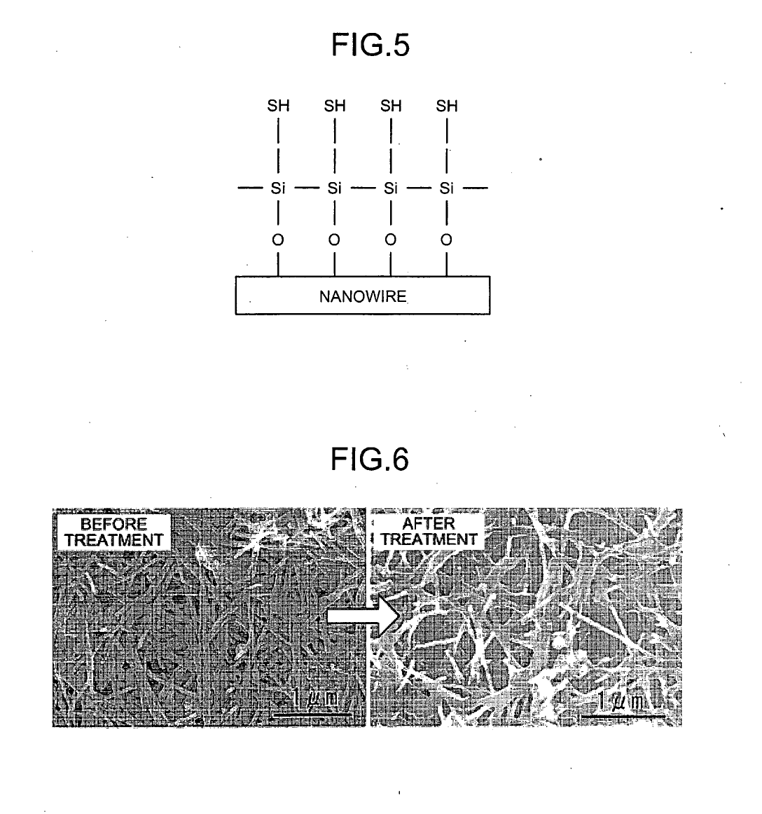

Then, the nanowires having been subjected to ultrasonication are dried at 80° C. for 1 hour. In this way, silane coupling-treated nanowires are formed. FIG. 5 is a schematic diagram for explaining one example of the surface structure of a silane coupling-treated nanowire.

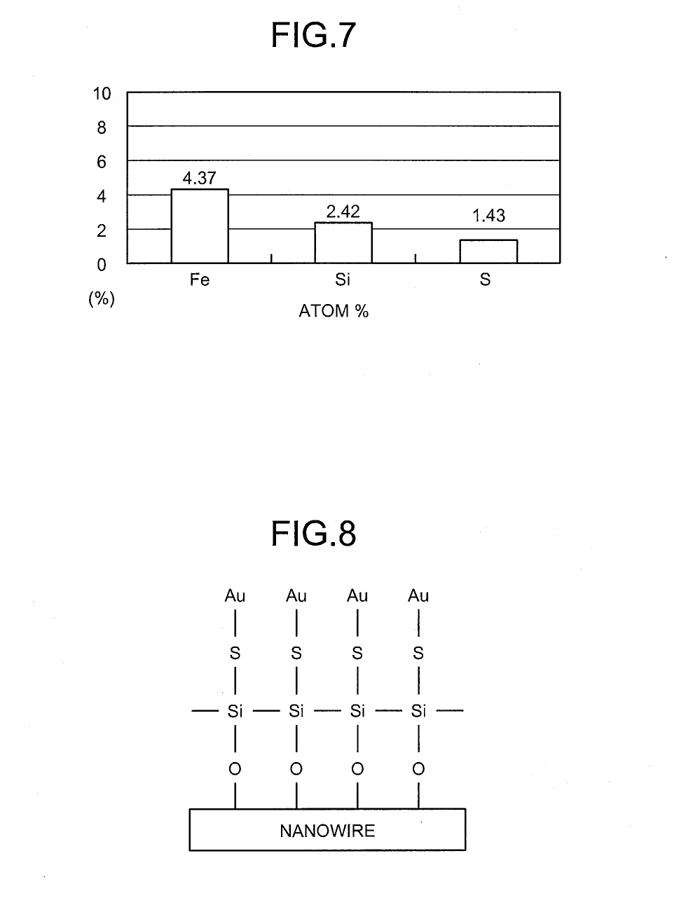

In this case, as shown in FIG. 5, 3-mercaptopropyltrimethoxysilane is used as a silane coupling agent, and therefore mercapto groups are provided as substituent groups. FIG. 6 provides scanning electron microscope (SEM) images of one example of iron nanowires taken before and after coating with a silane coupling agent. FIG. 7 is a graph for explaining the result of energy dispersive X-ray (EDX) analysis of silane coupling-treated nanowires.

As can be seen from FIG. 6, the iron nanowires having been subjected to silane coupling treatment in such a manner as described above are coated with a silane coupling agent. Furthermore, as shown in FIG. 7, it has been confirmed by EDX analysis that the silane coupling-treated nanowire contains Si and S atoms derived from the silane coupling agent.

Then, the nanowires having been subjected to silane coupling treatment in such a manner as described above are incubated in a colloidal gold solution for one day to coat the nanowires with gold. The colloidal gold solution is prepared by, for example, mixing 1 mL of 1 wt % HAuCl₄.4H₂O and 79 mL of ion-exchanged water at 60° C., adding 4 mL of 1 wt % citric acid thereto, and incubating the mixture at 80° C. for 5 minutes. FIG. 8 is a diagram for explaining one example of the surface structure of a nanowire coated with gold.

As shown in FIG. 8, the hydrogen atom of each mercapto group is replaced with gold by incubating the nanowires in the colloidal gold solution. This makes it possible to prevent the nanowires from being oxidized even when the nanowires are made of an easily-oxidizable material such as iron.

The above-described treatment is one example of treatment for coating the surface of nanowires with gold using a silane coupling agent. It is to be noted that the above-described silane coupling treatment is merely one example, and therefore another coupling agent such as a titanium coupling agent may be used. Furthermore, according to the purpose of a substance to be coupled to the nanowires, a silane coupling agent having a substituent such as a vinyl group, an epoxy group, an amino group, a methacrylic group, a carboxyl group, or a phosphonic acid group may be used. For example, by treating the nanowires with an amino group-containing silane coupling agent, it is possible to allow the surface of the nanowires to have amino groups. In this case, an organic substance such as a fluorescent material, single-strand DNA, an antibody, chemokine, dextran, polylactic acid, polystyrene can be coupled to the amino groups by a normal organic chemical reaction. In the combined magnetic body, the nanowires constituting a core layer may be coated with an intermediate layer containing a phagocytic signal, and the intermediate layer may be coated with a functional layer containing a biofunctional molecule. Such treatment as described above for coupling a certain substance to the surface of the nanowires may be carried out during or after the formation of a combined magnetic body that will be described later.

By treating the surface of the nanowires in such a manner as described above, it is also possible to impart molecular recognition properties to the nanowires. For example, when the surface of the nanowire is coated with gold, the nanowire can recognize thiol, a fluorescent material, or a cell. When the surface of the nanowire has hydroxyl groups or carboxyl groups, the nanowire can recognize cytochrome that is a protein. When the surface of the nanowire has phosphonic acid groups, the nanowire can recognize DNA. In these cases, the nanowire can be used as a biosensor.

Method for Forming Combined Magnetic Body

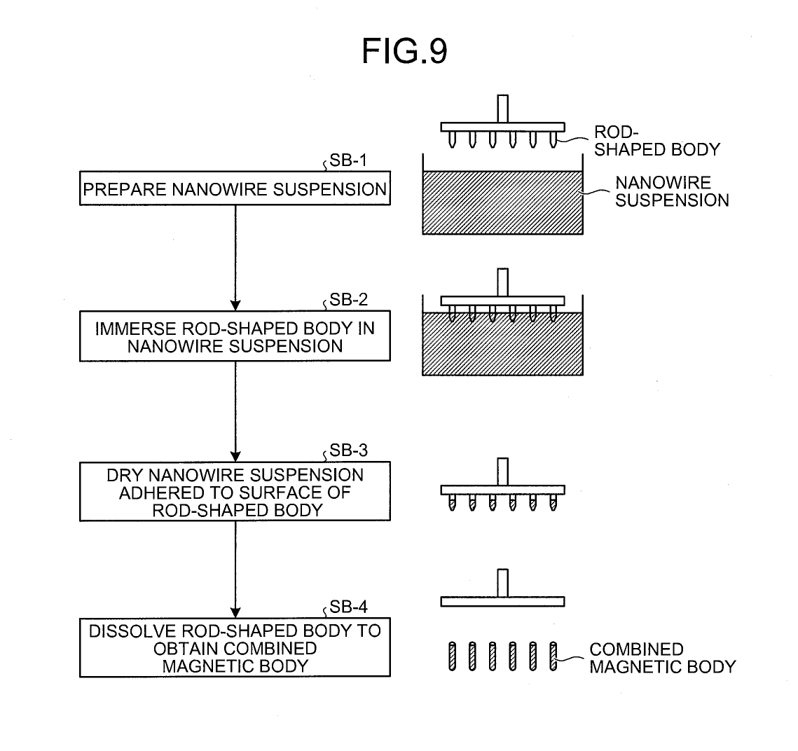

Next, a method for forming a tubular or a basket-shaped combined magnetic body by combining the nanowires produced as described above will be explained below. FIG. 9 is a flow chart with schematic diagrams for explaining one example of the method for forming basket-shaped combined magnetic bodies.

First, as shown in FIG. 9, the magnetic nanowires are suspended to prepare a nanowire suspension (Step SB-1). At this step, a soluble binder (an easily-dissolvable material such as fibrin, sugar, or polylactic acid) may be added to the suspension so that a finally obtained combined magnetic body can be dissolved in a living body after a lapse of a certain period of time.

Then, soluble rod-shaped bodies are immersed in the nanowire suspension (Step SB-2).

Then, the nanowire suspension adhered to the rod-shaped bodies is dried (Step SB-3).

Then, the rod-shaped bodies are dissolved to obtain basket-shaped combined magnetic bodies (Step SB-4).

In such a manner as described above, basket-shaped combined magnetic bodies are formed. It is to be noted that tubular combined magnetic bodies can also be formed in the same manner as described above, except that, for example, the rod-shaped bodies are immersed in the nanowire suspension without adhering the nanowire suspension to the tip of each of the rod-shaped bodies at the step SB-2.

Configuration of Combined Magnetic Body Injection Control System

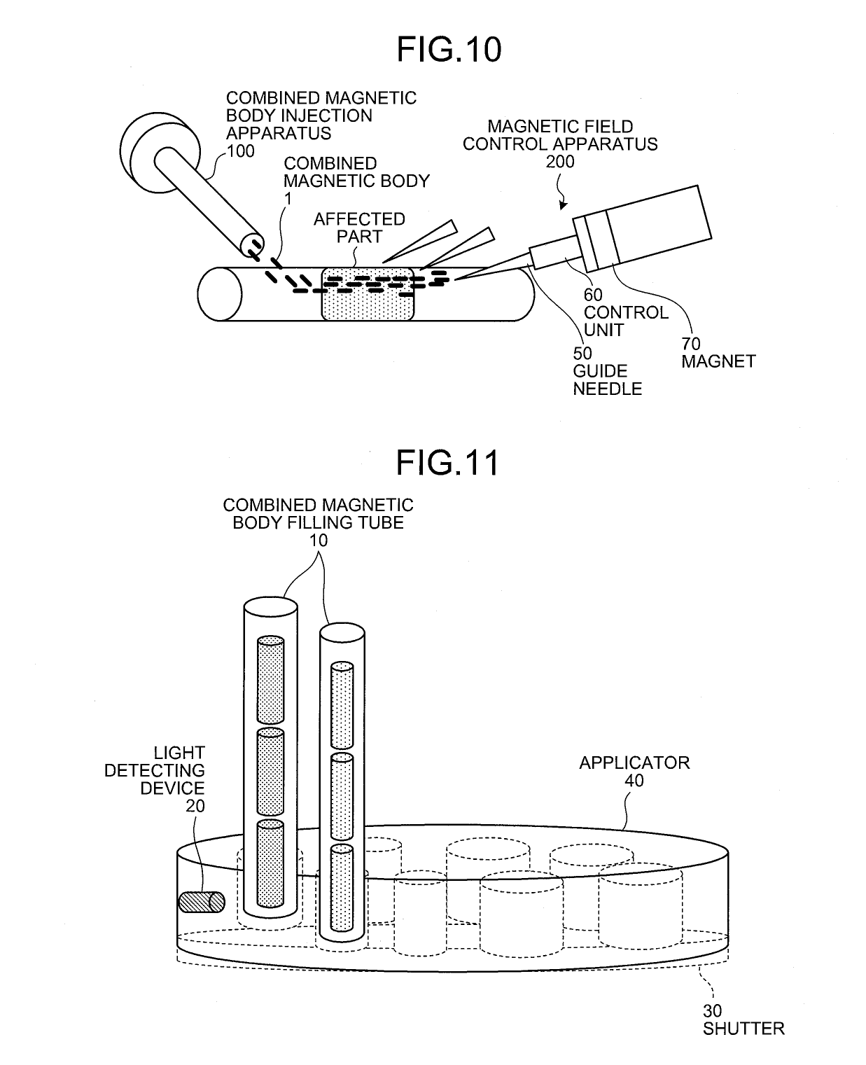

A configuration of the combined magnetic body injection control system will be explained below with reference to FIGS. 10 to 21. FIG. 10 is a diagram for explaining one example of the total structure of the combined magnetic body injection control system

As shown in FIG. 10, the combined magnetic body injection control system includes a combined magnetic body injection apparatus 100 and a magnetic field control apparatus 200. FIG. 11 is a diagram for explaining one example of the structure of the combined magnetic body injection apparatus 100.

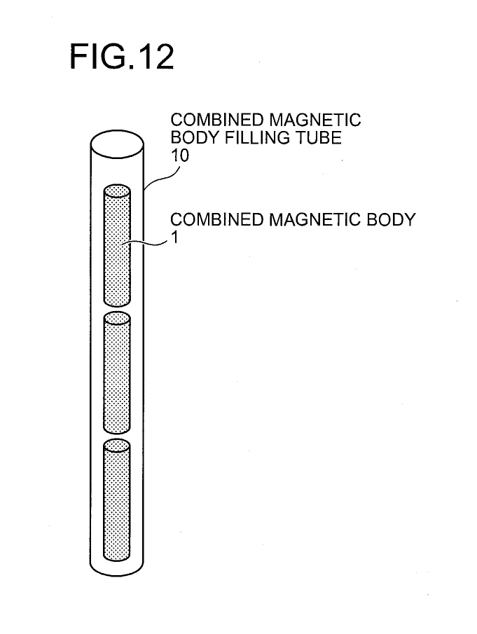

As shown in FIG. 11, the combined magnetic body injection apparatus 100 includes a combined magnetic body filling tube 10, a light detecting device 20, a shutter 30, and an applicator 40. FIG. 12 is a schematic diagram for explaining one example of the structure of the combined magnetic body filling tube 10.

As shown in FIG. 12, the combined magnetic body filling tube 10 is made of a light-permeable nonmagnetic material and has a hole having a larger inner diameter than the diameter of the combined magnetic body. More specifically, when used, a required number of the combined magnetic body filling tubes 10 previously prepared according to the intended use, such as transplantation therapy, are filled with the combined magnetic bodies and attached to the applicator 40. Examples of the nonmagnetic material include metals such as stainless steel and aluminum and organic materials such as plastic materials. The combined magnetic body filling tube 10 may have an inner diameter of, for example, 10 to 200 μm and a length of, for example, 100 μm to 10 cm in consideration of the diameter and length of the combined magnetic body, and may have an outer diameter of 200 to 2000 μm to ease attachment to the applicator 40. Furthermore, in order to prevent the combined magnetic bodies from being adhered to the inner wall of the combined magnetic body filling tube 10, the combined magnetic body filling tube 10 may be filled with a suspension obtained by suspending the combined magnetic bodies in an artificial spinal fluid that may contain a lubricant.

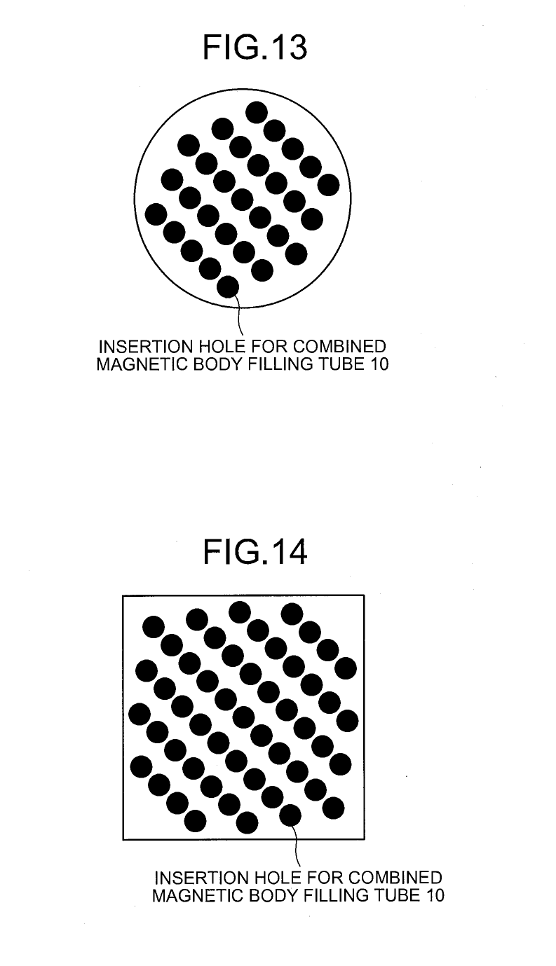

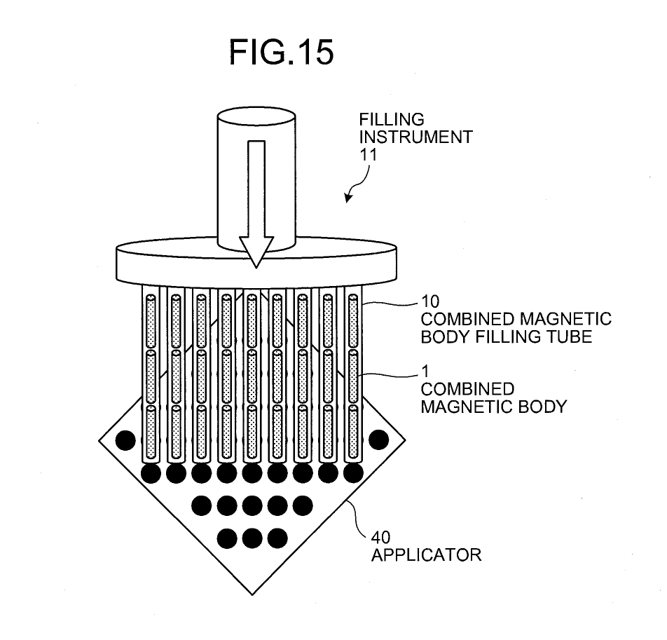

The applicator 40 is a system having holes to which the combined magnetic body filling tubes 10 can be detachably attached like cartridges. The applicator 40 is used in such a manner that one surface thereof opposite to the surface to which the combined magnetic body filling tubes 10 are attached is brought into close contact with tissue such as spinal cord. It is to be noted that in FIG. 11, the vertical scale has been compressed for easy reference. The applicator 40 has, for example, a lotus root-like shape. Like an indwelling needle, the applicator 40 may be made of a material such as an acrylic material or a plastic material and may have an unsharp tip. FIGS. 13 and 14 are diagrams for explaining examples of the cross section of an applicator 40. As shown in FIGS. 13 and 14, the applicator 40 has, for example, a circular or rectangular cross section where insertion holes are arranged in a honeycomb-like pattern. It is to be noted that the applicator 40 shown in the drawings is of a brain/spinal cord surface contact type, but may be configured to have a cross-sectional diameter of 3 mm or less so as to be able to be inserted into tissue. FIG. 15 is a diagram of one example of the filling instrument 11 for use in attaching the combined magnetic body filling tubes 10 filled with combined magnetic bodies to the applicator 40

As shown in FIG. 15, in order to attach the combined magnetic body filling tubes 10 to the applicator 40, a filling instrument 11 is used by way of example. The filling instrument 11 is formed by, for example, microminiaturizing the same mechanism as a multichannel pipette, and therefore the combined magnetic body filling tubes 10 corresponding to tips can be detachably fitted by insertion into the filling instrument 11. As shown in FIG. 15, the combined magnetic body filling tubes 10 can be attached to the applicator 40 by inserting the combined magnetic body filling tubes 10 into the insertion holes of the applicator 40 and pressing down a release lever provided in the filling instrument 11 to detach the combined magnetic body filling tubes 10 from the filling instrument 11.

Of the configuration of the combined magnetic body injection apparatus 100, the light detecting device 20 detects light crossing a cross section of the combined magnetic body filling tubes 10 near a tip of the combined magnetic body filling tubes 10. More specifically, the light detecting device 20 monitors the process of injecting the combined magnetic bodies 1 from the lateral face side of the combined magnetic body filling tube 10 to check, for example, that the combined magnetic bodies 1 are not agglomerated within the combined magnetic body filling tube 10 or the injection of the combined magnetic bodies 1 has been completed. The principles of such monitoring are as follows. When the agglomeration of the combined magnetic bodies 1 occurs within the combined magnetic body filling tube 10, optical transparency of the combined magnetic body filling tube 10 is reduced as compared to a case where the combined magnetic body filling tube 10 is normally filled with the combined magnetic bodies 1. On the other hand, after the completion of the injection of the combined magnetic bodies 1, optical transparency of the combined magnetic body filling tube 10 is increased as compared to a case where the combined magnetic body filling tube 10 is filled with the combined magnetic bodies. The light detecting device 20 may be configured to count the number of the combined magnetic bodies 1 having passed through the light detecting device 20. Monitoring results obtained by the light detecting device 20 may be output on the display screen of a computer or the like.

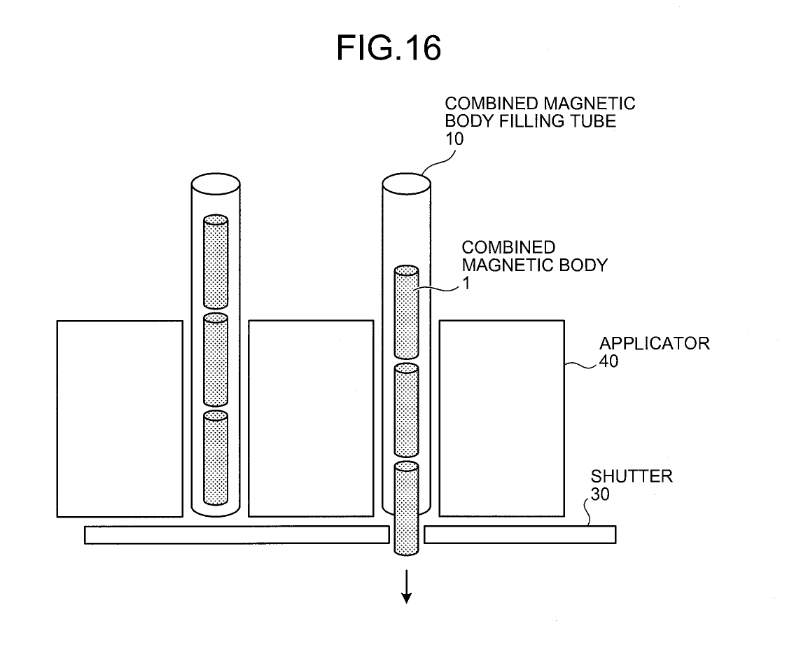

The shutter 30 controls the opening and closing of the hole of the combined magnetic body filling tube 10. The shutter 30 is controlled by, for example, a control unit such as a computer (not shown) so as to be opened or closed. As shown in FIG. 11, the shutter 30 is, for example, a member provided on the opposite side (i.e., on the tissue side) of the applicator 40 from the side, on which the combined magnetic body filling tubes 10 are inserted into the insertion holes, so as to be brought into direct contact with tissue. FIG. 16 is a schematic diagram for explaining the injection of combined magnetic bodies 1 contained in the combined magnetic body filling tube 10 through the shutter 30.

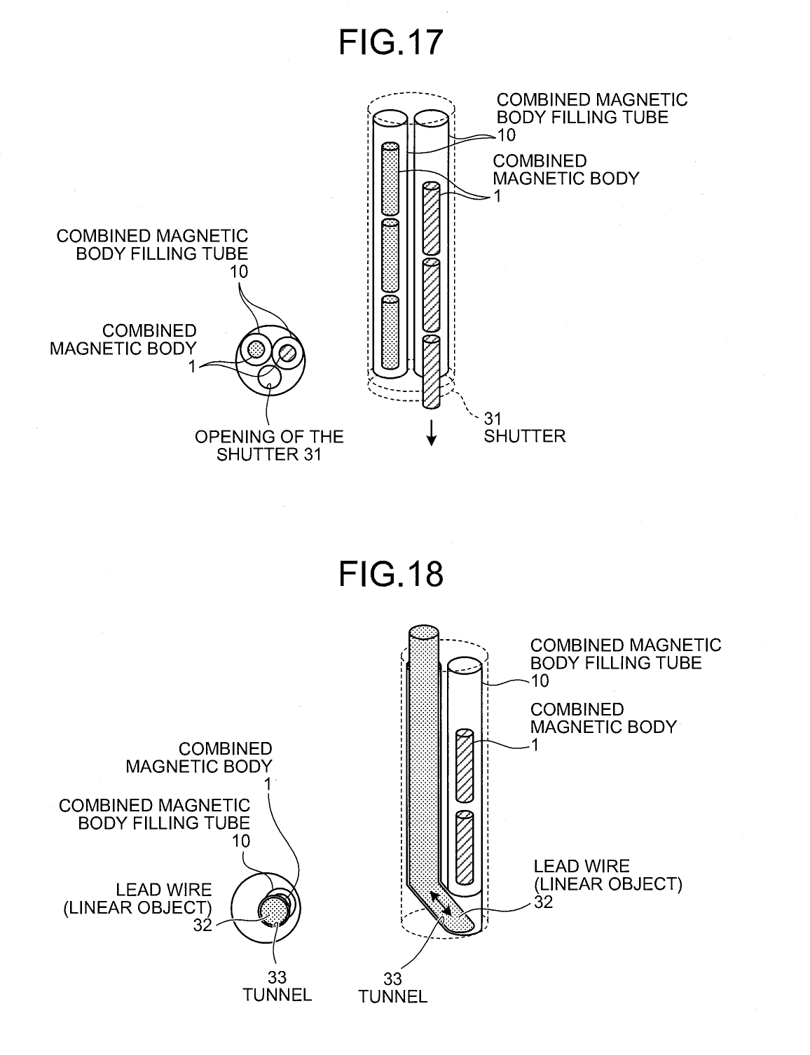

As shown in FIG. 16, when the hole of the combined magnetic body filling tube 10 is opened by controlling the shutter 30, the combined magnetic bodies 1 voluntarily enter tissue such as nervous tissue. The shutter 30 may be of a shutter rotation/movement type. In this case, the hole of the combined magnetic body filling tube 10 is exposed at the opening of the shutter 30 to be opened by rotating/moving the shutter 30 with respect to the applicator 40. Alternatively, the shutter 30 may be of an applicator rotation/movement type. In this case, the hole of the combined magnetic body filling tube 10 is exposed at the opening of the shutter 30 to be opened by rotating/moving the applicator 40 with respect to the shutter 30. The opening and closing mechanism of the shutter 30 may be of a revolver type having a plurality of openings. In this case, each of the openings may be independently controlled so as to be opened and closed. Such a mechanism of the shutter 30 makes it possible to control the order of injection or injection position of the combined magnetic bodies having various functions (molecules). FIG. 17 is a diagram of one example of the shutter 30 of a shutter rotation type or an applicator rotation type.

As shown in the sectional diagram on the left side of FIG. 17, when the hole of the combined magnetic body filling tube 10 is closed, it is not exposed at the opening of a shutter 31, and therefore the combined magnetic bodies 1 are not injected into tissue. On the other hand, when the position of the shutter 31 is relatively moved by rotating the shutter 31 with respect to the applicator 40, as shown in the diagram on the right side of FIG. 17, the hole of the combined magnetic body filling tube 10 is exposed at the opening of the shutter 31 to be opened so that the combined magnetic bodies 1 are injected into tissue. FIG. 18 is a diagram of another embodiment of the shutter system.

As shown in the sectional diagram on the left side of FIG. 18, another embodiment of the shutter system has a plug structure (e.g., a linear object such as a lead wire 32 made of a nonmagnetic material) for preventing the injection of the combined magnetic bodies through the hole of the combined magnetic body filling tube 10. For example, as shown in the perspective diagram on the right side of FIG. 18, the shutter system is configured so as to control the opening and closing of the hole of the combined magnetic body filling tube 10 by slidably inserting or removing the lead wire 32 into or from a tunnel 33 formed in the applicator 40 of the combined magnetic body injection apparatus 100. More specifically, when the lead wire 32 is inserted into the tunnel 33 so as to project into the hole of the combined magnetic body filling tube 10, movement of the combined magnetic bodies 1 toward the injection side is inhibited by the lead wire 32. On the other hand, when the lead wire 32 is pulled up in the upper direction in FIG. 18, the tip of the lead wire 32 is removed from the hole of the combined magnetic body filling tube 10, and therefore the combined magnetic bodies 1 can enter tissue along magnetic field. As described above, the combined magnetic body injection apparatus 100 having the shutter system shown in FIG. 17 or 18 by way of example can be configured to have a diameter of 2 mm or less allowing insertion into tissue such as brain.

As shown in FIG. 10, the magnetic field control apparatus 200 includes a guide needle 50, control unit 60, and magnet 70.

Of the configuration of the magnetic field control apparatus 200, the magnet generates magnetic field for guiding combined magnetic bodies. Examples of the magnet 70 include a permanent magnet, an electromagnet, and a superconducting magnet. The magnet 70 may be appropriately selected according to application to change the intensity of magnetic field etc.

The guide needle 50 is a needle for increasing the magnetic flux density of magnetic field generated by the magnet 70 at the tip portion thereof. The magnetic field is the strongest at the tip of the guide needle 50. The guide needle 50 is made of a magnetic material. As shown in FIG. 10, the number of the guide needles 50 to be used may be two or more, and the guide needle 50 is used by inserting it into tissue near target tissue such as an affected part or by bringing it into close contact with the surface of tissue.

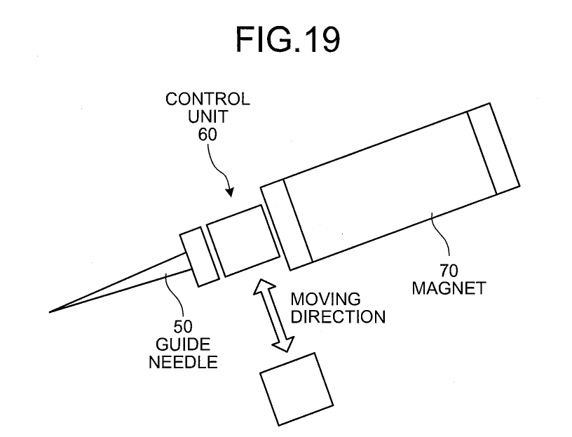

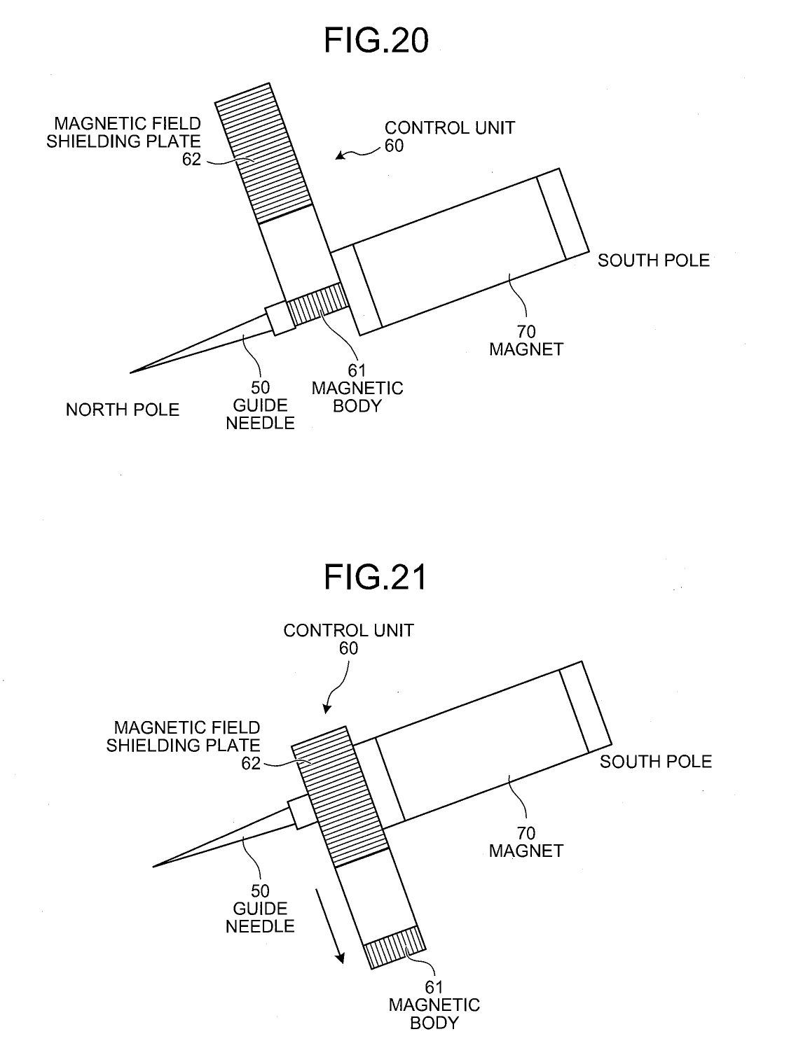

The control unit 60 controls magnetic field between the magnet 70 and the guide needle 50. FIG. 19 is a schematic diagram for explaining one example of magnetic field control carried out by the control unit 60. As shown in FIG. 19, when a magnetic portion of the control unit 60 is located between the magnet 70 and the guide needle 50, magnetic field generated by the magnet 70 reaches the guide needle 50 so that the magnetic field is enhanced at the tip of the guide needle 50. On the other hand, when the magnetic portion of the control unit 60 is removed from the space between the magnet 70 and the guide needle 50 by sliding it in a direction perpendicular to the longitudinal direction of the magnetic field control apparatus 200, the magnetic field generated by the magnet 70 does not reach the guide needle 50 and therefore magnetic field is not generated at the tip of the guide needle 50. This makes it possible to prevent the displacement of the combined magnetic bodies 1 having been moved in tissue along a magnetic gradient because magnetic field is not generated at the tip of the guide needle 50 when the guide needle 50 is removed from the tissue. FIGS. 20 and 21 are diagrams of an improved version of the control unit 60 shown in FIG. 19.

The improved version of the control unit 60 has a higher level of safety for clinical application, and includes a magnetic body 61 for guiding magnetic field to the guide needle 50 and a magnetic field shielding plate 62 for blocking magnetic field. As shown in FIG. 20, when the magnetic body 61 is located between the guide needle 50 and the magnet 70, the magnetic body 61 guides magnetic field generated by the magnet 70 to the guide needle 50 so that the magnetic field is enhanced at the tip of the guide needle 50. On the other hand, as shown in FIG. 21, when the magnetic field shielding plate 62 is located between the guide needle 50 and the magnet 70, the magnetic field shielding plate 62 blocks magnetic field generated by the magnet 70 so that magnetic field generated at the tip of the guide needle 50 is completely eliminated.

The above-described structure of the combined magnetic body injection control system according to the present embodiment is one example, and the combined magnetic body injection control system having such a structure as described above can be made compact and inexpensive and has a high level of safety because it hardly causes leakage of magnetic field.

Process of Combined Magnetic Body Injection Control System

One example of processes of the combined magnetic body injection control system configured as above will be explained below.

First, the applicator 40 and the shutter 30 of the combined magnetic body injection apparatus 100 are brought into contact with the surface of a site where the combined magnetic bodies are to be injected (e.g., tissue such as brain, spinal cord, liver, heart, kidney, or tumor tissue), and the guide needle 50 is previously inserted into a desired position or brought into contact with a surface at a desired position according to a desired direction in which the combined magnetic bodies are to be moved from the site where the combined magnetic bodies are to be injected.

Then, the guide needle 50 located at the desired position is connected to the magnetic field control apparatus 200 in which the control unit 60 is in a state where it does not guide magnetic field to the guide needle 50. Then, the control unit 60 is brought into a state where it guides magnetic field to the guide needle 50 to generate magnetic field required to align the combined magnetic bodies in a target site.

Then, the combined magnetic body filling tubes 10 are attached to the combined magnetic body injection apparatus 100 in which the shutter 30 is closed, and then the shutter 30 is controlled by, for example, a computer connected to the shutter 30 to open the hole of the combined magnetic body filling tube 10 containing the combined magnetic bodies at a desired position. This makes it possible to allow the combined magnetic bodies to voluntarily enter tissue so that the combined magnetic bodies are aligned along a magnetic gradient in the target site.

It is to be noted that the process of injecting the combined magnetic bodies is monitored by the light detecting device 20 of the combined magnetic body injection apparatus 100, and therefore the completion of injection of the combined magnetic bodies can be checked. The position of the combined magnetic bodies in tissue may be checked by a surgical CT/navigator.

This is the example of the progress of the combined magnetic body injection control system.

### Example

One example according to the present embodiment will be explained below.

According to WHO report, the number of deaths from neurological diseases amounts to 6,800,000 every year. In Europe, the economical cost of neurological diseases in 2004 is estimated at 139 billion euros. Japan is experiencing rapid aging of population, and the number of patients with neurological diseases such as cerebrovascular disorder (200,000 cases per year now) and Parkinson's disease (estimated number of patients: 100,000) will further increase in future. Furthermore, the number of patients with spinal cord damage common in young people, who are bearers of Japan's future, reaches 100,000. If reconstruction of damaged neuronal circuits (especially damaged motor system) becomes possible, its contribution to medical care and welfare is very high also from the viewpoint of medical care and welfare costs.

In recent years, multipotent cell/stem cell-related technologies have been developed, and therefore neuronal cell transplantation is expected as a last resort to reconstruct the function of the brain/spinal cord to treat brain/spinal cord diseases, that is, an ideal method for recovering the function of the damaged brain/spinal cord.

However, a conventional transplantation technique (a conventional neuronal cell transplantation method) cannot extend transplanted neurons and their neurites in the brain (even by 1 mm) and therefore neuronal circuits cannot be reconstructed. For this reason, satisfactory therapeutic effects cannot be obtained by the conventional transplantation technique. In the case of cerebrovascular disease, a glial scar is formed at and around a ischemia-lesioned site so that the movement of transplanted neurons and their neurites is blocked by the glial scar (physical barrier). Furthermore, the presence of a neurite outgrowth inhibiting system by myelin etc. is also a barrier (cell biological barrier). On the other hand, since a neurite reaches a target site using various molecules as signposts, irregular neurite outgrowth (e.g., ectopic sprouting of mossy fibers in the hippocampus) involves the risk of epileptic attack.

For this reason, clinical application of neuronal cell transplantation requires the control of extension direction of neurites. As described above, nerve transplantation is regarded as an ultimate treatment method for brain diseases, but is facing huge hurdles to surmount for clinical application. In conventional neuronal cell transplantation practically applied in a clinical setting, transplanted neuronal cells are expected to serve only as a source of a growth factor or dopamine for host neuronal cells. Therefore, there has been a strong demand for development of a technique to transplant neuronal cells, the technique can be applied in a clinical setting for treatment for which neurite outgrowth is required such as that for damaged motor nervous system.

Furthermore, a current transplantation technique also involves a problem that neuronal cells can only be transplanted at limited sites because tissue is damaged by an injecting needle.

With significant advances in research on induced pluripotent stem (iPS) cells and embryo-stem (ES) cells today, the present inventors have got an idea that if a technique can be established for flexibly controlling neurite outgrowth and its direction in the brain/spinal cord to reconstruct neuronal circuits, the treatment of brain/spinal cord diseases will be significantly advanced. More specifically, neurites reach target sites using various molecules as signposts (scaffolds) in the process of brain development, and therefore if transplanted neuronal cells can form a synapse with neurons at the target sites without inhibition by barriers while being guided by signposts, nerve function lost due to disease will be recovered.

One object of the present invention is to put into practical use, a novel technique to transplant neuronal cells, in which combined magnetic bodies (preferably magnetic bodies having adhesion molecules or a growth factor coupled thereto) are “wired” by high magnetic field in the brain to reconstruct neuronal circuits using the magnetic bodies as scaffolds. More specifically, one object of the present invention is to complete a technique required to apply the novel technique to the treatment of brain/spinal cord diseases and to apply such a technique in clinical settings early.

Therefore, the present inventors have developed a technique for laying magnetic bodies, which serve as scaffolds for neurites, at any site and in any direction in the brain through collaboration between medicine and engineering. Examples of medical application of a conventional magnetic structure include techniques for separating DNA or lymphocytes using magnetic nanobeads. However, magnetic susceptibility enough to move neuronal cells or neurites in brain tissue cannot be obtained by such nanobeads. The present inventors have researched the effect of magnetic field on living bodies by analyzing health effects of superhigh magnetic field (10 teslas) on human cells, and as a result, have focused attention on a magnetic wire. This is because a magnetic wire has higher magnetic susceptibility than a magnetic nanobead and therefore its motion can be controlled, and the area of contact between cells and the magnetic wire is much larger than that between cells and the magnetic nanobead.

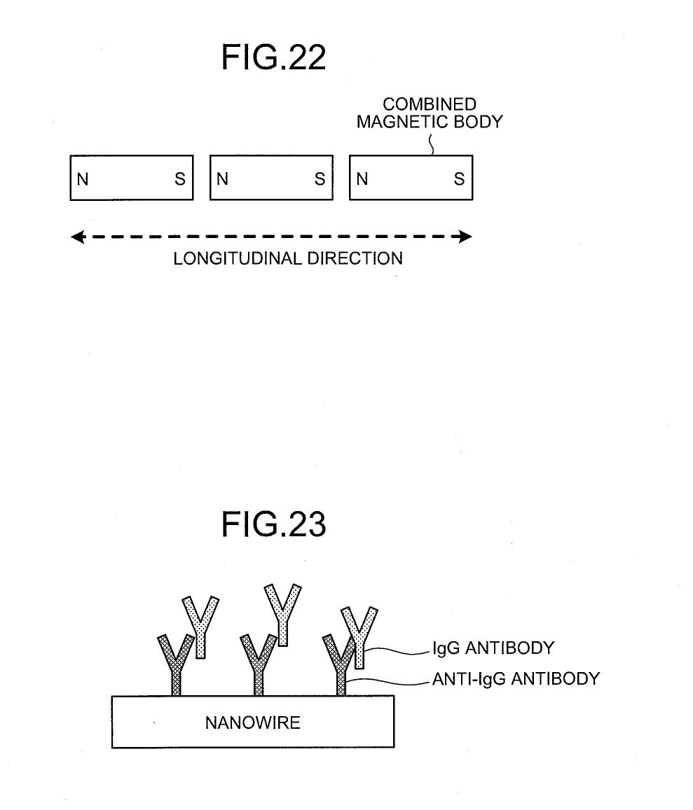

Thanks to the recent advancement of nanotechnology, it has become possible to produce a large quantity of uniform magnetic wires to be used in the present example having a diameter of 50 nm to 100 μm and a length of 1 to 500 μm. Such magnetic wires have the following advantages: (1) the wires having various diameters (50 nm to 100 μm) can be made; (2) the wires are magnetized in their longitudinal direction due to their slim shape; (3) the wires can be produced in large quantity; (4) the wires can have a sufficient amount of functional molecules coupled or applied thereto by surface treatment; and (5) the wires can be continuously aligned in nervous tissue. FIG. 22 is a schematic diagram for explaining the chain formation of the magnetic bodies in their longitudinal direction.

As shown in FIG. 22, the magnetic bodies can only be magnetized in their longitudinal direction in magnetic field due to their shape (e.g., length/radius=about 1000) (i.e., anisotropy is large), and therefore chain formation of the magnetic bodies occurs. More specifically, the magnetic bodies (nanowires) are aligned in parallel with the direction of magnetic field due to magnetic moment so that chain formation of the magnetic bodies (nanowires) occurs by bonding between the south pole and the north pole of the adjacent magnetic bodies. Therefore, by controlling the direction of magnetic field, it is possible to easily lay the “rail” of the magnetic bodies (nanowires) in the brain.

According to a nanowire production method used in the present example, it is possible to produce nanowires having the same shape and size in large quantity at one time. The nanowires can be chemically modified by suspending them in ethanol solution or aqueous solution just after production. As a result of research and development, it has become possible to allow an organic compound to be coupled to the surface of the nanowires and to allow protein molecules to be coupled to the surface of the nanowires via an organic compound as a spacer (see the above-described method for producing a combined magnetic body). As described above, the development of materials and the advancement of magnetic field control techniques have created an environment where magnetic field and nanotechnology can be utilized to solve the above-described medical issues.

The advancement of superconducting technology has made it possible to produce a very small superconducting magnet generating high magnetic field, and therefore the present inventors have studied the application of high magnetic field to the present example. Until now, the present inventors have studied the application of high magnetic field to the present example toward practical use by using various superhigh magnetic field generators and superconducting magnets generating high magnetic field up to 13 teslas.

The present example will be explained blow in order of (1) Development of Intelligent Magnetic Wire, (2) Development of Technique for Aligning Magnetic Structures at Target Site in Brain by High Magnetic Field and Technique for Nondestructively Detecting Nanowires in Brain, and (3) Study of clinical application.

(1) Development of Intelligent Magnetic Wire

The present inventors have developed a ferromagnetic nanomaterial (nanowire) that has no toxicity even when injected into the brain and can be easily aligned by magnetic field. Furthermore, the present inventors have succeeded in coupling an organic compound as an anchor to the nanowire. Therefore, an experiment was performed using a nanowire having poly-L-lysine coupled thereto as nonspecific nerve adhesion molecules. More specifically, in order to induce neurite outgrowth, an adhesion molecule-coupled nanowire (A1) was used as a scaffold to reconstruct neuronal circuits by controlling magnetic field. Furthermore, the present inventors have designed a soluble resin-coupled nanowire (A2) that can exhibit its effect also on adjacent tissue due to diffusion action, and have developed a novel drug delivery system (DDS) for allowing a nerve functional factor (e.g., a protein such as a neurotrophic factor, an antibody for function control, a drug, or siRNA for suppression of protein expression) to act on a certain site in the brain only for a necessary period of time. The following magnetic bodies A1 and A2 produced according to the present example are different in functionality, and the following magnetic bodies B1 and B2 produced according to the present example are different in shape. The functionality and the shape may be combined according to the intended use to form a magnetic wire of, for example, an A1B2 type or an A2B1 type.

A1. Cell Adhesion Molecule-Coupled Wire

A cell adhesion molecule-coupled wire is obtained by coupling a certain compound to the surface of the magnetic wire. Examples of such a cell adhesion molecule-coupled wire include a poly-L-lysine-coupled wire and an antibody-coupled wire for general purpose use. Poly-L-lysine is the most inexpensive nonspecific neurite adhesion factor and exhibits its function stably. FIG. 23 is a diagram for explaining one example of the surface structure of an antibody-coupled wire for general purpose use.

As shown in FIG. 23, the antibody-coupled wire for general purpose use is obtained by coupling a (humanized) anti-mouse IgG antibody to the surface of the nanowire. It is possible to freely couple various mouse IgG antibodies to the surface of the nanowire without losing their function, thereby allowing two or more molecules having an influence on nerve function to be controlled at the same time. This makes it possible to effectively reconstruct neuronal circuits in imitation of the process of nerve system development.

A2. Drug Eluting-Type Intelligent Wire—DDS for Central Nerve

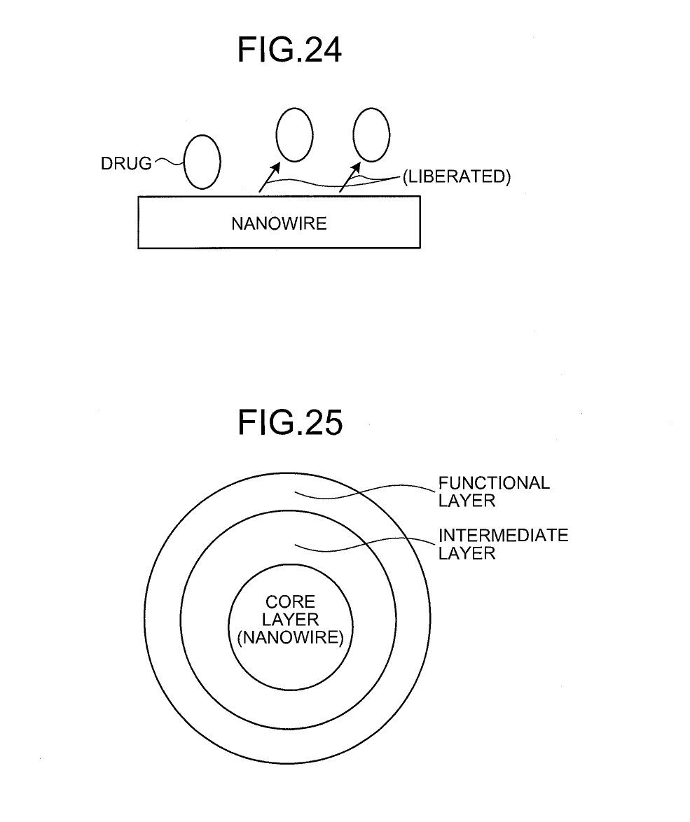

The drug-eluting nanowire is designed to sustainably release a protein (e.g., a growth factor, an adhesion molecule, an antibody), a drug, siRNA (for suppressing protein expression by RNA interference), or the like in the brain/spinal cord. The present inventors have developed a surface coating technique for allowing molecules to drop off the surface of a magnetic body after a lapse of a certain period of time in the brain. FIG. 24 is a schematic diagram for explaining one example of the surface structure of a drug-eluting nanowire.

As shown in FIG. 24, the use of such a drug-eluting nanowire makes it possible to exert the effect of a nerve function molecule or a drug also on neuronal cells or neurites that are not in direct contact with the nanowire. Particularly, it becomes possible to administer a concentration gradient-dependent liquid factor or growth factor to a wide range of brain tissue without damaging the brain tissue.

Drug-eluting metal coating techniques have been already applied in clinical settings to provide drug-eluting stents for use in treatment of myocardial infarction (prevention of coronary artery reocclusion). The drug-eluting nanowire according to the present example has been developed based also on these already-established techniques. More specifically, it has been confirmed that organic materials used for drug-eluting coronary stents such as methacrylate (methacrylic resin, acrylic resin) and biomolecules such as fibrin, matrix proteins, polysaccharides, polylactic acid, and polylysine can be used as substrates to be liberated form the nanowire.

The development of a polylactic acid-based base material (polylactic acid-based matrix) for use in treatment of brain cancer (liberation of an antitumor drug) has already been addressed, and therefore such a polylactic acid-based base material has been studied as a promising base material for use in surface coating of the intelligent magnetic body having low toxicity for nervous tissue. Such a drug-eluting nanowire is expected to be used for treatment of various neurological diseases.

Furthermore, the magnetic nanowire can be made multifunctional by forming a multilayer coating on the surface thereof. FIG. 25 is a sectional diagram of one example of a magnetic wire obtained by laminating an intermediate layer containing a phagocytic signal on a nanowire as a core layer and further laminating a functional layer containing biological functional molecules on the intermediate layer.

A 50 nm nanowire has substantially the same size as bacteria. By coupling a phagocytic signal (e.g., polylysine) for macrophages to the surface of such a nanowire, it is possible for the macrophages to immediately phagocytize the nanowire so that the nanowire is removed from brain tissue. If the magnetic nanowire has a size that cannot be phagocytized by macrophages, the magnetic nanowire is localized in the brain.

Therefore, when the intermediate layer (e.g., a layer containing polylysine as a phagocytic signal) is coated with the functional layer containing a drug, a growth factor, or the like, the functional layer disappears by dissolution after its function is completed, and therefore the polylysine layer is exposed and the localized nanowire is removed by macrophages from the brain. This makes it possible to eliminate the possibility that tissue damage is caused by the nanowire (originally, it can be considered that there is little possibility that tissue damage is caused by the nanowire). Examples of the biofunctional molecule of the functional layer include a drug, a growth factor, an adhesion molecule, a monoclonal antibody, a virus vector, siRNA.

It is to be noted that the intelligent magnetic body can be used alone for treatment. By allowing the magnetic wire to have drug-eluting function by using the surface coating technique for allowing molecules to drop off the surface of a magnetic body after a lapse of a certain period of time in the brain, it is possible to use the magnetic wire having drug-eluting function for treatment of various neurological diseases.

B1. Rod-Shaped Wire

A rod-shaped wire is a single nanowire having high magnetic susceptibility but a relatively small surface area. The newly developed nanowire according to the present example is produced by depositing a ferromagnetic material such as iron by an electrolytic method in the nanopores of a mold obtained by anodizing an aluminum plate. According to such a method, it is possible to produce a large quantity of nano-sized wires (about 10¹⁰ to 10¹² wires) having the same shape and size (diameter: several tens of nanometers, length: several micrometers to several tens of micrometers) at one time and to control the length of the nanowires so that the nanowires can have any length. The nanowire according to the present example is made of iron by way of example, but the present inventors have also developed nanowires made of materials having a higher biocompatibility and low toxicity such as platinum and titanium.

The rod-shaped wire having a diameter of 50 nm has the same size as bacteria, and therefore can be removed by phagocytosis by phagocytes (e.g., microglias), but is not suitable as a scaffold for constructing neuronal circuits at a target site after a lapse of a certain period of time. Therefore, such a 50 nm rod-shaped wire is used for, for example, activation of immune cells (treatment of infection diseases), supply of a growth factor (a dosing period can be controlled), and production of a shaped large-sized wire (combined magnetic body). On the other hand, a rod-shaped wire having a diameter of 200 nm is not phagocytized by phagocytes such as microglias and therefore can be placed for a long period of time at a target site, but is inferior in tissue penetrating power to the 50 nm wire. Therefore, such a 200 nm rod-shaped wire is used for, for example, local continuous administration of a growth factor (treatment of neurological incurable diseases) and construction of short neuronal circuits (recovery of higher brain function).

In order to couple nerve function control molecules and the like to the nanowire produced, the surface of the nanowire is preferably coated with an organic compound. Such coating is carried out by using, for example, a technique for forming SAM (Self Assembled Monolayer). For example, an organic material can be coupled to a nickel nanowire by treating the nickel nanowire with hematoporphryn IX that is an organic fluorescent material so that the organic fluorescent material can be attached to the surface of the nickel nanowire. The present inventors have developed a nanowire having, in its outermost surface, poly-L-lysine coupled to alkyl groups coupled to the surface of the nanowire made of iron. Such a nanowire can be used for an experiment of neuronal cell transplantation. The properties of such an organic compound coating applied onto the surface of the nanowire (e.g., stability of coupling, degree and strength of coating) were analyzed and improved.

In the present example, the optimizations of the material of a biocompatible nanowire, a nanowire having a surface suitable for coating, an organic material having an affinity for both the surface of a nanowire and a cell, and an anchor molecule that connects a cell spreading factor to a nanowire were performed. Therefore, various material combinations were studied, and coating conditions, the kind of solute, temperature, pH, stirring conditions, and drying conditions were also studied to be optimized. The surface condition of a magnetic wire produced and the state of coupling were evaluated using a scanning electron microscope and an infrared spectrometer.

B2. Meshed Wire (Combined Magnetic Body)

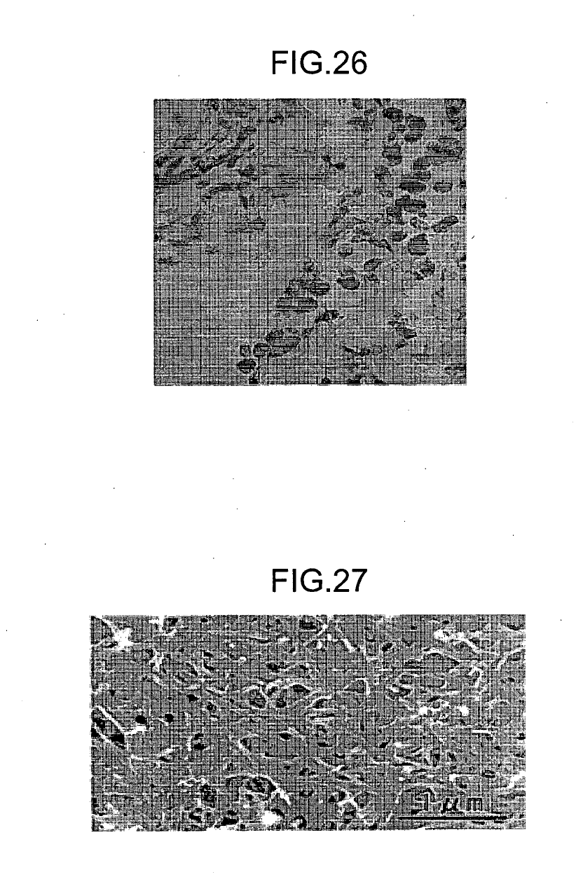

A meshed wire is obtained by binding together nanowires (having a diameter of, for example, 50 nm) to form a meshed tube having a diameter of 50 to 100 μm. Such a meshed wire (combined magnetic body) has the following advantages: (1) the meshed wire has a large surface area per unit volume and therefore is suitable as a scaffold for neurites; (2) the meshed wire can be decomposed into original single 50 nm wires (bacteria size) after a lapse of a certain period of time by using a soluble binder (e.g., fibrin, sugar, polylactic acid) as a binder, and therefore the localized wires are removed by phagocytes such as macrophages after their function is completed; and (3) stem cells or the like can be encapsulated in the meshed wire to allow such cells to be moved in tissue. FIG. 26 is a photomicrograph for explaining the removal of nanowires from a transplantation site by phagocytes.

FIG. 27 is a photomicrograph of a meshed wire (combined magnetic body) obtained by forming 50 nm wires into a mesh structure. The solubility of the meshed wire (combined magnetic body) can be regulated by binding together nanowires with a soluble binder (i.e., a soluble material such as fibrin, sugar, or polylactic acid) so that the binder can be dissolved in a living body after a lapse of a certain period of time. This makes it possible to control the length of time to decompose and remove the meshed wire.

The simple wire (B1) is advantageous in tissue penetrating power and cost, and on the other hand, the meshed wire (B2) is advantageous in that it has a large surface area and it can be removed from tissue by, for example, macrophages. Furthermore, neuronal cells to be transplanted can be encapsulated in a basket-shaped wire or cylindrical wire having a diameter of 50 to 100 μm to transport the neuronal cells to a target site accurately.

The meshed wire having a diameter of 50 μm can be easily moved in brain tissue. Furthermore, the moving range of the meshed wire can be limited by the hardness of tissue by appropriately selecting magnetic field intensity. Therefore, it is possible to move the meshed wires only in the site of cerebral edema, or to lay wire circuits from the surface to the inside of the brain, or to perform wiring without inflicting a wound (injection hole) in the brain. As described above, such a meshed wire is versatile and has a high level of safety, and is therefore expected to be used for treatment of spinal cord injury, treatment of cerebral stroke (especially, treatment of mobility impairment and sensory impairment), and treatment of cerebral edema. On the other hand, the meshed wire having a diameter of 100 μm has the strongest tissue penetrating power. Therefore, a tunnel in which neuronal cells are moved can be formed in the brain by allowing the meshed wires to penetrate brain tissue, and wire circuits can be laid from the surface to the inside of the brain. Such a meshed wire is expected to be used for drug delivery to the site of cerebral tumor, destruction of tumor, movement of transplanted cells in the brain (long distance), treatment for cerebral stroke (reconstruction of neuronal circuits), and providing an electrode for brain-machine interface.

As described above, the present inventors have developed various magnetic wires that have no toxicity when injected into a living body and can be easily aligned by magnetic field. Ultrapure iron nanowires were injected into the brain of rats (normal rats and cerebral infarction rats), and these rats (N=10) were monitored for 3 months. As a result, cerebral local inflammation and convulsive attack were not observed, and no rats died. The ultrapure iron nanowire coated with polylysine can be kept stable for 1 year even in a normal saline solution without rusting, but an iron.platinum wire was also produced to achieve perfect safety for clinical application. Furthermore, the present inventors have completed a technique for coupling and liberating a protein (e.g., an adhesion molecule, a growth factor, a nerve repellent factor) or a molecule for controlling the function of such a protein (e.g., a monoclonal antibody, siRNA, a drug) in the brain/spinal cord. Furthermore, the present inventors have developed a novel drug delivery system (DDS) for allowing a protein or a drug to act on a certain site in the brain only for a necessary period of time. For example, in the case of treatment of cancer such as malignant tumor, it is possible to locally suppress a cancer gene or to locally administer an antitumor drug. In the case of treatment of myocardial infarction, cardiomyopathy, and arteriovenous embolism, it is possible to newly form blood vessels at a certain site by an angiogenesis factor or the like, or to locally supply a growth factor for cardiac muscle, or to control gene expression at a certain site by using siRNA or a vector.

(2) Development of Technique for Aligning Magnetic Structures at Target Site in Brain/Spinal Cord by High Magnetic Field and Technique for Detecting Nanowires (Combined Magnetic Bodies) in Brain/Spinal Cord

Development of Magnetic Field Control Apparatus

The present inventors have developed a magnetic body injection control system (magnetic field generation/control apparatus) according to the present example for aligning ferromagnetic wires in nervous tissue. More specifically, the present inventors have developed a high magnetic field control technique for moving and aligning nanowires (combined magnetic bodies) in the brain/spinal cord in clinical practice. This technique can be applied also to the control of movement of nanowires (combined magnetic bodies) not only in the brain but also in other organs.

The present inventors had already developed a method for aligning nanowires (combined magnetic bodies) at a depth of 1 to 2 cm from the surface of the brain with the use of a neodymium permanent magnet. The present inventors have further developed an injecting device (a microinjector) for minimizing an alignment error (an alignment error of 2 mm or less can be achieved at present) and accurately controlling the direction in which magnetic wires are injected and the amount of magnetic wires to be injected.

When the present invention is applied to treatment of spinal cord injury, a compact magnetic field control device using a permanent magnet suffices as a magnetic field control device, and therefore it is not necessary to refurbish an operating room. On the other hand, a superconducting magnet of 3 teslas or higher is required to align nanowires (combined magnetic bodies) at a depth of 5 cm or more from the surface of the brain. In this case, it is absolutely necessary to shield magnetic field to prevent the influence of the magnetic field on other medical instruments. The present inventors have made an experiment on control of leaked magnetic field using a superconducting thin film and a superconducting bulk material (manufactured by Nippon Steel Corporation). As a result, the present inventors have succeeded in controlling the direction of magnetic flux. Furthermore, it has been demonstrated by the experiment that superhigh magnetic field can be focused in a certain direction in the brain by using the superconducting bulk material. As a result, the present inventors have reached a conclusion that a superconducting magnet can be used in an operating room.

On the other hand, an alignment error increases as the distance between the magnet and a target site in the brain increases. However, particularly in transplantation therapy for Perkinson's disease, it is necessary to accurately align nanowires (combined magnetic bodies) in a deep portion of the brain (in the corpus striatum). In this case, it is considered that such transplantation therapy can be safely and reliably carried out by a method in which a magnetic field control guide needle connected to a magnet is inserted into the corpus striatum by a stereotaxic operation to accurately guide magnetic wires. The use of a guide needle made it possible to accurately localize magnetic wires also in the corpus striatum of a rat.

(3) Study of Clinical Application

Target Diseases

Target diseases of the present example are spinal cord injury and Perkinson's disease expected to be most effectively treated, and the present inventors have focused efforts particularly on spinal cord injury. The reasons for this are as follows: the goal for therapy is clear (i.e., motor function recovery (corticospinal tract)) and the number of patients is large; the design of magnetic field for wire alignment is easy because neurites linearly run in the spinal cord; wires can be aligned under direct vision; and ethical resistance to transplantation into the spinal cord is lower than that to transplantation into the brain.

The present inventors have regarded Perkinson's disease as a candidate for transplantation of neuronal cells into the brain because the fact that motor function is improved by substitution of dopamine-producing neurons in the substantia nigra has already been confirmed through experiments and it can be expected that a sufficient therapeutic effect will be obtained also in the case of humans if dopamine-producing cells can be arranged over a wide area in the corpus striatum. It is to be noted that improvement of motor function in patients with cerebral stroke (pyramidal disorder) is also a major theme of the present example.

Spinal cord injury and Perkinson's disease are common in that the number of patients is large and improvement in movement disorder is directly linked with improvement in activities of daily living (ADL). In Japan, as many as 100,000 patients are suffering from the after effects of spinal cord injury (equivalent to the total number of Perkinson's disease patients), and 5000 patients are newly diagnosed with spinal cord injury every year. Many spinal cord injury patients are adolescent, which is a very serious problem not only for patients themselves but also for society. However, from another viewpoint, young patients are excellent in brain plasticity, and therefore it can be expected that their motor function will be further improved by treatment with combination of efficient rehabilitation. The number of Perkinson's disease patients increases as society ages, and therefore also from the viewpoint of welfare and nursing-care policies, there is a strong demand for practical application of nerve transplantation.

Fundamental Research Using Experimental Animals

Nerve function control nanowires and neuronal cells (neurons prepared from a fetus, neurons differentiated from iPS cells or ES cells) were transplanted in the brain of rats, and the nanowires were aligned by magnetic field. Neurite outgrowth can be evaluated by transplantation of neuronal cells derived from a GFP (green fluorescent protein) transgenic rat (transplanted neuronal cells and their neurites can be easily detected by green fluorescence emitted from them).

The basic data of measurement of limit of tolerance to external force (cell fluidity measurement by laurdan, cytoskeletal protein staining) carried out on neuronal cells in the above-described in-vitro experiment are important to determine the risk that neuronal cells are damaged by the unexpected movement of the nanowires due to superhigh magnetic field. Furthermore, there is a possibility that the nanowires penetrate the brain and reach the meninx or skull. However, the nanowires are moved in the longitudinal direction thereof (diameter: 50 nm), and therefore it can be considered that the risk of tissue destruction or bleeding is very low.

Cells to be Transplanted

The present inventors have studied the use of not only rat fetal neuronal cells but also neuronal cells derived from iPS cells or ES cells occupying an important place in medical transplantation. Furthermore, a differentiation-inducing factor for such a neural stem cell can be sustainably administered using drug-eluting nanowires, and therefore the present inventors have examined whether the risk of tumorigenic transformation of the transplanted neural stem cells is suppressed in the brain by the drug-eluting nanowires (stem cell differentiating factor) injected together with the neural stem cells.

Nanowire as Novel DDS (Administration of Neurotrophic Factor)

When neural connections between neuronal cells are cut off by an affected area, the neural cells gradually atrophy and drop off. However, progression of nerve damage can be prevented to some extent by supplying a neurotrophic factor. Therefore, there is a possibility that neural death can be prevented by moving nanowires having a growth factor (e.g., HGF, GDNF) coupled thereto to a target site. Such a method according to the present example can provide an efficient drug delivery system (DDS) to a central nerve system for releasing a drug at a certain site in the brain with safety.

Method According to the Present Example

Heretofore, there have been no reports about research directed toward brain transplantation and prevention of neuronal death (aging) using nanowires not only in Japan but also in other countries. Under present circumstances, the limit of nerve transplantation is that neurite outgrowth in the brain is impossible, but there are few ideas to overcome such a limit. There are many reports in which supply of a growth factor was carried out by infecting nervous tissue with a virus into which a neurotrophic factor gene had been inserted. However, sustained supply of a sufficient amount of growth factor only to a target site has been heretofore impossible.

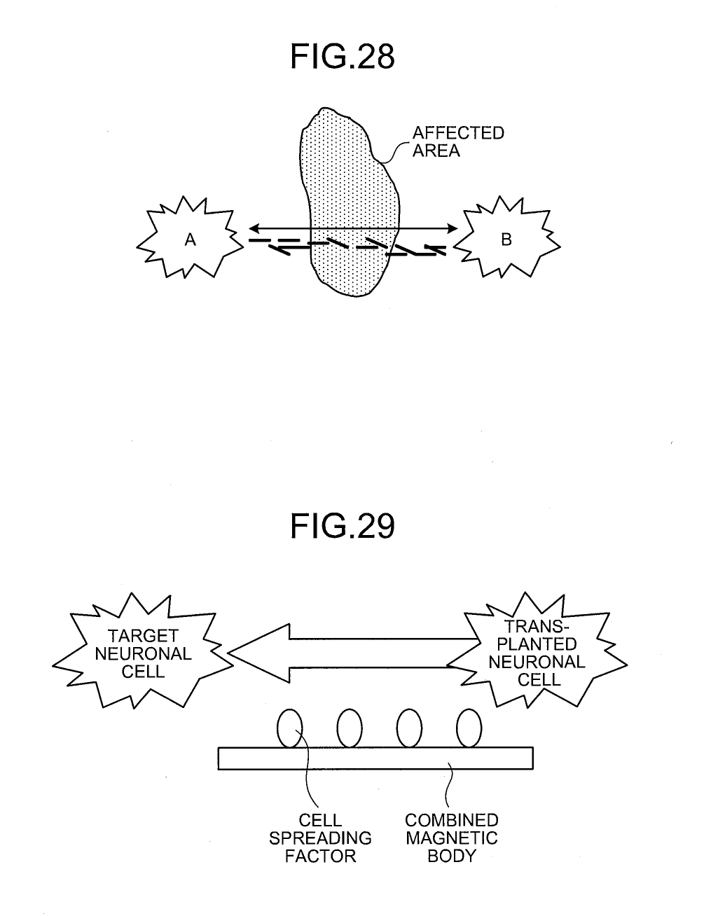

According to the present example, an intelligent magnetic body (diameter: 50 nm to 100 μm) is formed by coupling functional molecules that induce neurite outgrowth to a nanowire so that the functional molecules can be liberated from the nanowire. More specifically, combined magnetic bodies formed by coupling functional molecules such as a neurite extension factor, an antibody or a drug for suppressing a nerve repellent factor, and a neurotrophic factor to nanowires are aligned at a certain site in the brain/spinal cord by high magnetic field to expose neurites to the functional molecules or release the functional molecules for a certain period of time. This makes it possible to form a synapse between a transplanted neurite and a target neuronal cell to reconstruct neuronal circuits. FIG. 28 is a schematic diagram for explaining a situation where combined magnetic bodies are aligned by magnetic field so as to cross an affected site at which nerve connections (represented by the left and right arrow) between a region A and a region B are blocked by nerve damage and lose their function. FIG. 29 is a schematic diagram for explaining a situation where neurites or transplanted neuronal cells move along nanowires (combined magnetic bodies) having nerve function control molecules, such as a cell spreading factor, coupled to the surface thereof so that neuronal circuits are formed between the transplanted neuronal cells and target neuronal cells.

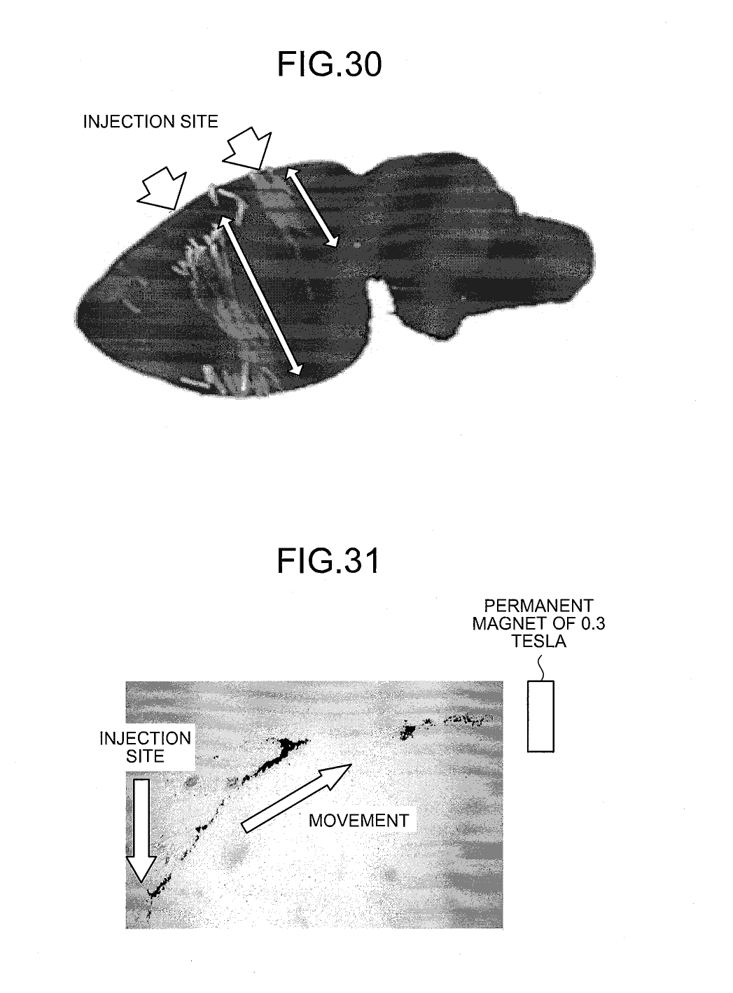

As shown in FIG. 28, when nerve connections between a region A and a region B are blocked by nerve damage and loses their function, transplanted neuronal cells (transplanted neurons) usually cannot extend neurites into tissue even by 1 mm due to inhibition by a glial scar and a neurite extension inhibiting factor such as myelin so that connections between the region A and the region B are not recovered. In this case, the combined magnetic bodies obtained by coupling a nerve function control factor to nanowires are arranged in a chain by magnetic field to connect together the region A and the region B to lay a rail through which neurites extend. More specifically, as shown in FIG. 29, transplanted neuronal cells can move or extend neurites along the cell spreading factor provided on the nanowires constituting the combined magnetic bodies without inhibition by the affected area. It is to be noted that cell adhesion molecules or a nonspecific adhesion material such as poly-L-lysine may be coupled to the nanowires. FIG. 30 is a three-dimensional CT image of the brain of a rat.

Surface-treated magnetic bodies were injected into the surface of the right and left cerebral cortex (“injection site” shown in FIG. 30), and were then guided in the direction of the base of the brain by a magnet of 0.6 tesla. As a result, as shown in FIG. 30, the magnetic bodies were linearly arranged in the ranges shown by the left and right arrows. The present inventors have succeeded in allowing the magnetic bodies to penetrate the brain in the range shown by the left-hand left and right arrow and in allowing the magnetic bodies to be aligned between the cerebral cortex and the diencephalons in the range shown by the right-hand left and right arrow. It is to be noted that in this experiment, an injecting needle was not inserted into the brain because the magnetic bodies were dropped onto the surface of the brain (onto a portion just below the pia mater) and guided to a target site (necessary time: about 10 minutes). FIG. 31 is a micrograph taken when nanowires (50 nm) injected into the brain of a rat were guided by externally-applied magnetic field using a permanent magnet.

As can be seen from FIG. 31, the nanowires injected into the cerebral cortex were guided by the magnet and were therefore moved from the injection site by about 2 mm in the brain (black points represent aggregated nanowires). From the result, it has become clear that the nanowires can be controlled by magnetic field also in the brain of a rat.

Furthermore, when the magnetic bodies were dropped onto the surface of the cerebral cortex of a rat (the cerebral dura mater and the arachnoid mater were removed) and a permanent magnet of 0.4 tesla was arranged on the opposite side of the brain, the nanowires crossed the brain and were continuously arranged to form a nanowire chain of 1 cm in about 2 minutes. The use of a superconducting magnet of 3 teslas made it possible to move the magnetic bodies separated from the superconducting magnet by 10 cm or more. The creation of a magnetic gradient by inserting a guide needle connected to the tip of the magnet into the brain made it possible to more accurately guide the magnetic bodies (in the case of localization in the corpus striatum, the magnetic bodies were accurately moved by 0.5 cm). This result indicates that a compact magnetic field control device using a permanent magnet can be used for a brain/spinal cord transplantation operation usually performed (moving distance: about 1 cm), and such magnetic bodies can be satisfactorily applied in clinical settings without repair of an operation room.

The safety of the simultaneous transplantation of functional molecule-coupled nanowires and neuronal cells to the brain of a rat was also evaluated. As a result, the simultaneous transplantation of poly-L-lysine-coupled nanowires and cultured rat cerebrocortical neuronal cells did not cause a reduction in a survival ratio (the length of observation: 5 days). Furthermore, when poly-L-lysine-coupled nanowires were administered to cerebral infarction rats, dropping-off of poly-L-lysine from the nanowires was hardly observed, and abnormal behavior, worsening of paralysis, reduction in survival rate, and convulsion attack were not observed (even after a lapse of 3 months).

Furthermore, the present inventors have succeeded in noninvasive imaging of nanowires distributed in the brain of a rat with the use of a super-high-resolution CT. The present inventors have developed a basic technique for detecting the three dimensional location of magnetic nanoparticles, a spinal cord transplantation technique, an animal motor function evaluation technique, and a phase contrast X-ray CT technique. Although it is difficult to detect a trace quantity of magnetic bodies with the use of X-ray usually used, the present inventors have succeeded in detecting a trace quantity of magnetic bodies with the use of radiant light. High-resolution analysis using phase contrast CT was also possible.

From the results of the experiment carried out to evaluate the movement of nano-sized structures by magnetic field, it has become clear that a wire having a diameter of 50 μm and a length of 100 to 300 μm is most excellent in balance between mobility in the brain and controllability. In the case of the nanowire having such a size, it was possible to allow the nanowires to directly reach a target site from the surface of the brain without using an injecting needle (without stereotaxic operations).

Result and Consideration

The present inventors have developed a technique for constructing new neuronal circuits in transplanted neurites and then in host neurites by transplanting neuronal cells (nerve stem cells) and nerve control molecule-bonded nanowires (combined magnetic bodies) at the same time or by transplanting neuronal cells after the nanowires (combined magnetic bodies) are aligned in the brain. This has made it possible to establish a method for reconstructing lost nerve function, especially motor circuits by establishing nerve connections across a glial scar, which is considered impossible in current brain transplantation. Further the present inventors have developed a technique for releasing a neurotrophic factor or a drug for a certain period of time by moving drug-releasing nanowires (combined magnetic bodies) to a target site to supply a growth factor thereto to treat neurodegenerative diseases such as Perkinson's disease and ALS.

The present inventors have also developed a technique for speedily observing the action of a certain molecule (e.g., nerve adhesion factor, neurotrophic factor) or a drug in the brain of an animal at low cost. For example, by allowing certain molecule-coupled nanowires (combined magnetic bodies) to be aligned at a certain site in the brain to sustainably release the certain molecule, it is possible to pathologically, biochemically, and ethopharmacologically analyze the function of the molecule. Such a technique becomes a useful tool not only in the field of neuroscience but also in the field of various medical researches by using it in combination with knockout mice or transgenic mice.

One object of the present example is to reconstruct damaged neuronal circuits in the brain to recover nerve function. It can be considered that the technique for flexibly moving and extending neurites in the brain/spinal cord, which has been established by the present inventors, is useful for treatment of patients suffering from cerebral dysfunction irrespective of the cause of nerve disease. Furthermore, supply of a drug or a growth factor to a certain site in the brain, which has been considered impossible by a conventional drug delivery system, becomes possible by the drug-releasing nanowire. Therefore, the technique is useful also for the treatment of neurodegenerative diseases (e.g., Perkinson's disease, motor neuron disease, Alzheimer's disease). A superhigh magnetic field/cell function control-type nanowire system functions as an in-vivo nanomachine. This can be applied not only to brain transplantation that is the object of the present example but also to treatment of diseases of other organs. Therefore, the technique according to the present example is highly universal.

The elemental technologies developed according to the present example are a method for producing a nano-sized magnetic material according to its intended use, a technique for controlling the nano-sized magnetic material, and a technique for detecting the nano-sized magnetic material. One object of the present example is to apply these elemental technologies to a living body, but it can be considered that these elemental techniques can be applied also to other various techniques such as a technique for examining a biological material in vivo. For example, it can be considered that these elemental techniques make it possible to detect tumor cells, and therefore they can be applied to cancer treatment. Furthermore, these elemental techniques can be biologically applied to biosensors and artificial nerve.

The nano-sized material control/detection technique developed according to the present example can also be applied to the field of pure industry such as non-destructive inspection. The present example is directed to a technique for controlling/detecting the movement of a substance injected into a living body, and the application range of such a technique is wide. For example, the present example can be applied also to treatment using a micro robot or a nano robot because such treatment uses a position control/detection technique. Furthermore, the magnetic body can be used as an environmental material. For example, the magnetic body can be used as a filter for adsorbing harmful materials.

### Another Embodiment

The embodiment of the present invention has been described above. However, the present invention may be carried out in not only the embodiment described above but also various different embodiments within the technical idea described in the scope of the invention.

In the embodiments, the case where the combined magnetic body injection apparatus 100 and the magnetic field control apparatus 200 performs the process in the form of stand-alone device is explained as one example. However, the combined magnetic body injection apparatus 100 and the magnetic field control apparatus 200 may be configured to perform the process according to a request from a client terminal which is provided separately from these apparatuses.

Of each of the processes explained in the embodiment, all or some processes explained to be automatically performed may be manually performed. Alternatively, all or some processes explained to be manually performed can also be automatically performed by a known method.

In addition, the procedures, the control procedures, the specific names, the information including parameters such as registered data and searching conditions, the screens, and the database configurations which are described in the literatures or the drawings can be arbitrarily changed unless otherwise noted.

With respect to the combined magnetic body injection apparatus 100 and the magnetic field control apparatus 200, the constituent elements shown in the drawings are functionally schematic. The constituent elements need not be always physically arranged as shown in the drawings.

For example, all or some processing functions of the devices in the combined magnetic body injection apparatus 100 or the magnetic field control apparatus 200 can be realized by a CPU (Central Processing Unit) and a program interpreted and executed by the CPU or can also be realized by hardware realized by a wired logic. The program is recorded on a recording medium (will be described later) and mechanically read by the combined magnetic body injection apparatus 100 as needed. More specifically, on the storage unit such as a ROM or an HD, a computer program which gives an instruction to the CPU in cooperation with an OS (Operating System) to perform various process is recorded. The computer program is executed by being loaded on a RAM, and constitutes a control unit in cooperation with the CPU. The “recording medium” includes an arbitrary “portable physical medium” such as a flexible disk, a magnet-optical disk, a ROM, an EPROM, an EEPROM, a CD-ROM, an MO, or a DVD or a “communication medium” such as a communication line or a carrier wave which holds a program for a short period of time when the program is transmitted through a network typified by a LAN, a WAN, and the Internet. The “program” is a data processing method described in an arbitrary language or a describing method. As a format of the “program”, any format such as a source code or a binary code may be used. The “program” is not always singularly constructed, and includes a program obtained by distributing and arranging a plurality of modules or libraries or a program that achieves the function in cooperation with another program typified by an OS (Operating System). In the apparatuses or the device according to the embodiments, as a specific configuration to read a recording medium, a read procedure, an install procedure used after the reading, and the like, known configurations and procedures can be used.

The combined magnetic body injection apparatus 100 and the magnetic field control apparatus 200 may be realized by connecting a known information processing apparatus such as a personal computer or a workstation and installing software (including a program, data, or the like) which causes the information processing apparatus to realize the method according to the present invention.

Furthermore, a specific configuration of distribution and integration of the devices is not limited to that shown in the drawings. All or some devices can be configured such that the devices are functionally or physically distributed and integrated in arbitrary units depending on various additions.

### INDUSTRIAL APPLICABILITY

As described above in detail, according to the present invention, it is possible to provide a combined magnetic body that has a high tissue penetrating power and is capable of achieving both long-term placement in a living body and removal by phagocytes and of transporting a large amount of material or a large-sized object, a combined magnetic body production method for producing the combined magnetic body, an combined magnetic body injection apparatus for injecting the combined magnetic body, a combined magnetic body injection control system for controlling the injection of the combined magnetic body, a magnetic field control apparatus for controlling the movement of the combined magnetic body, and a combined magnetic body injection control method for controlling the injection of the combined magnetic body. For this reason, the present invention is very useful in various fields such as medical care, medicine manufacture, drug discovery, biological research, nanotechnology, and clinical examination.

1. A combined magnetic body comprising a plurality of nanowires composed of a magnetic material, wherein the nanowires are combined together to be formed into a tubular structure or a basket-shaped structure.

2. The combined magnetic body according to claim 1, wherein the tubular structure or the basket-shaped structure accommodates a cell, a protein, a hormone, a peptide, a drug, an organic compound, a nucleic acid, sugar, or lipid.

3. The combined magnetic body according to claim 1, wherein the nanowires constitute a core layer, and wherein the core layer is coated with an intermediate layer containing a phagocytic signal, and the intermediate layer is coated with a functional layer containing a biofunctional molecule.

4. The combined magnetic body according to claim 3, wherein the functional layer contains, as the biofunctional molecule, a drug, a protein, sugar, a virus vector, siRNA, an antibody, a growth factor, or an extracellular matrix.

5. The combined magnetic body according to claim 3, wherein the intermediate layer or the functional layer contains a substrate to be liberated such as an organic material (e.g., methacrylate), fibrin, a matrix protein, polysaccharide, heparin, a heparin-like molecule, or polylactic acid.

6. A combined magnetic body production method for producing a combined magnetic body, comprising:
a first step of preparing a suspension by suspending a plurality of nanowires composed of a magnetic material;
a second step of immersing a soluble rod-shaped body in the suspension;
a third step of drying the suspension adhered to the rod-shaped body; and
a fourth step of forming a tubular or basket-shaped combined magnetic body, in which the nanowires are combined together, by dissolving the rod-shaped body.

7. A combined magnetic body injection apparatus, comprising:
a combined magnetic body filling tube, the tube being composed of a light-permeable nonmagnetic material and having a hole larger than a diameter of the combined magnetic body according to claim 1;
a light detecting system that detects light crossing a cross section of the tube near a tip of the tube; and
a shutter system that controls the opening and closing of the hole of the tube.

8. The combined magnetic body injection apparatus according to claim 7, wherein the shutter system has a plug structure that prevents the combined magnetic body from being injected through the hole of the tube, and wherein the plug structure is slidably inserted into and removed from the hole of the tube to control the opening and closing of the hole.

9. A combined magnetic body injection control system, comprising:
a combined magnetic body injection apparatus including a combined magnetic body filling tube composed of a light-permeable nonmagnetic material and having a hole larger than a diameter of the combined magnetic body according to claim 1; and
a magnetic field control apparatus including a magnetic field generator that generates magnetic field for guiding the combined magnetic body, and a control unit that controls the movement of a magnetic field shielding plate for blocking the magnetic field.

10. A magnetic field control apparatus, comprising:
a magnetic field generator that generates magnetic field for guiding the combined magnetic body according to claim 1;
a guide needle that increases a magnetic flux density of the magnetic field generated by the magnetic field generator; and
a control unit that controls the movement of a magnetic field shielding plate for blocking the magnetic field between the magnetic field generator and the guide needle.

11. A combined magnetic body injection control method, executed by a combined magnetic body injection control system comprising:
a combined magnetic body injection apparatus including a combined magnetic body filling tube composed of a light-permeable nonmagnetic material and having a hole larger than a diameter of the combined magnetic body according to claim 1, a light detecting system that detects light crossing a cross section of the tube near a tip of the tube, and a shutter system that controls the opening and closing of the hole of the tube; and
a magnetic field control apparatus including a magnetic field generator that generates magnetic field for guiding the combined magnetic body, and a control unit that controls the movement of a magnetic field shielding plate for blocking the magnetic field, wherein
the method includes:
a first step of moving the magnetic field shielding plate to allow the magnetic field generated by the magnetic field generator to pass, the first step being executed by the control unit of the magnetic field control apparatus;
a second step of controlling the shutter system to open the hole of the tube, the second step being executed by the combined magnetic body injection apparatus; and
a third step of checking whether the combined magnetic body has been injected by controlling the light detecting system to detect the light crossing the cross section of the tube, the third step being executed by the combined magnetic body injection apparatus.
